(19) United States
(12) Patent Application Publication
(10) Pub. No.: US 2008/0300962 A1
(43) Pub. Date: Dec. 4, 2008

(54) Lead distribution and tracking with integrated corporate data usage and reporting capabilities

(76) Inventors: Christopher Robert Cawston, Toronto (CA); Michael Pun, Richmond Hill (CA); Kwok-Leung Elvis Lam, Toronto (CA); Kenneth Lo, Markham (CA); Sin Leung Law, Richmond Hill (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, CA

(21) Appl. No.: 11/806,470

(22) Filed: May 31, 2007

(51) Int. Cl. G06F 17/30

(52) U.S. Cl. 705/10

(57) ABSTRACT

A system for distributing a plurality of leads for vehicles over a network from a plurality of disparate lead sources to a targeted lead destination, the system comprising: an import module configured for receiving the plurality of leads in an electronic format and for associating a unique identifier with each lead of the plurality of leads, each of the leads including customer contact information, customer location information, and vehicle information; a tracking module configured for creating a report record for each said lead for use in tracking a status of each said lead, the report record associated with the unique identifier of each said lead; a delivery module configured for assigning each said lead to a selected vehicle dealership based on the lead information, the vehicle dealership associated with a network address of the targeted lead destination and for communicating each said lead to the network address; and a collector module configured for receiving from the targeted lead destination respective feedback data associated with each said lead, the respective feedback data including the unique identifier of each said lead, and configured for storing the feedback data for each said lead in the report record associated with the unique identifier of each said lead.

### BACKGROUND

Vehicle manufacturers need a consolidated approach to collect, qualify and collect by dealer, sales leads and distribute the leads to dealers. Currently, manufacturers use disparate processes and formats to distribute leads to their dealers. Accordingly, dealers may receive duplicate leads via different or the same lead source and the dealers therefore may not recognize that they have previously received a lead for this consumer.

Further, the tracking and management of lead performance is desirable given today's fast paced and competitive marketplace for vehicle purchases. However, due to the current use of disparate lead systems, few customers who requested vehicle information receive any timely follow-up from a dealer. It is a problem of the prior art to coordinate lead follow-up at the dealership level, in order to optimize the type of leads and manner in which the lead types are processed by the dealers. Further, it is needed to deliver a higher percentage of qualified leads to dealers and a system to facilitate prioritization of leads based on lead quality.

### SUMMARY

There is a need for a method and a system for lead management that overcomes or otherwise mitigates at least one of the disadvantages of the prior art.

One aspect provided is a system for distributing a plurality of leads for vehicles over a network from a plurality of disparate lead sources to a targeted lead destination, the system comprising: an import module configured for receiving the plurality of leads in an electronic format and for associating a unique identifier with each lead of the plurality of leads, each of the leads including customer contact information, customer location information, and vehicle information; a tracking module configured for creating a report record for each said lead for use in tracking a status of each said lead, the report record associated with the unique identifier of each said lead; a delivery module configured for assigning each said lead to a selected vehicle dealership based on the lead information, the vehicle dealership associated with a network address of the targeted lead destination and for communicating each said lead to the network address; and a collector module configured for receiving from the targeted lead destination respective feedback data associated with each said lead, the respective feedback data including the unique identifier of each said lead, and configured for storing the feedback data for each said lead in the report record associated with the unique identifier of each said lead.

A second aspect provided is a method for distributing a plurality of leads for vehicles over a network from a plurality of disparate lead sources to a targeted lead destination, the method comprising the acts of: receiving the plurality of leads in an electronic format; associating a unique identifier with each lead of the plurality of leads, each of the leads including customer contact information, customer location information, and vehicle information; creating a report record for each said lead for use in tracking a status of each said lead, the report record associated with the unique identifier of each said lead; assigning each said lead to a selected vehicle dealership based on the lead information, the vehicle dealership associated with a network address of the targeted lead destination; communicating each said lead to the network address; receiving from the targeted lead destination respective feedback data associated with each said lead, the respective feedback data including the unique identifier of each said lead, and storing the feedback data for each said lead in the report record associated with the unique identifier of each said lead.

A third aspect provided is a system for providing a plurality of qualified leads for vehicles over a network to a selected vehicle dealership, the system comprising: a receipt module configured for receiving a plurality of initial leads in an electronic format and for identifying a unique identifier with each lead of the plurality of initial leads, each of the initial leads including customer information and vehicle information; a data module configured for supplementing the lead information with supplemental information identified from a data store based on the lead information to transform the plurality of initial leads into the plurality of qualified leads, through searching the data store for any matches to selected data fields of the lead information, the data store including the supplemental information that is associated with at least one of the customer information or information on the selected vehicle dealership, each of the plurality of qualified leads retaining the unique identifier associated with each of the corresponding initial leads; and a delivery module configured for communicating each said qualified lead to the selected vehicle dealership based on the lead information for subsequent lead follow-up.

A fourth aspect provided is a method for providing a plurality of qualified leads for vehicles over a network to a selected vehicle dealership, the method comprising the acts of: receiving a plurality of initial leads in an electronic format; identifying a unique identifier with each lead of the plurality of initial leads, each of the initial leads including customer information and vehicle information; supplementing the lead information with supplemental information identified from a data store based on the lead information to transform the plurality of initial leads into the plurality of qualified leads, through search results of the data store for any matches to selected data fields of the lead information, the data store including the supplemental information that is associated with at least one of the customer information or information on the selected vehicle dealership, each of the plurality of qualified leads retaining the unique identifier associated with each of the corresponding initial leads; and communicating each said qualified lead to the selected vehicle dealership based on the lead information for subsequent lead follow-up.

### BRIEF DESCRIPTION OF THE DRAWINGS

These and other features will become more apparent in the following detailed description in which reference is made to the appended drawings by way of example only, wherein:

FIG. 1 is a block diagram of a lead management environment;

FIG. 2A is an example delivered lead of the environment of FIG. 1;

FIG. 2B is an example available lead of the environment of FIG. 1;

FIG. 2C an embodiment of the leads of FIGS. 2A and 2B;

FIG. 3 is an example of activity of the management engine of FIG. 4;

FIG. 4 is a block diagram of the management engine of FIG. 1;

FIG. 5A is a further embodiment of the environment of FIG. 1;

FIG. 5B is a further embodiment of the consolidation engine of FIG. 1;

FIG. 5C shows a further embodiment of the leads of FIGS. 2A, B;

FIG. 5D is a further embodiment of the leads of FIGS. 2A, B;

FIG. 5E is a further embodiment of the leads of FIGS. 2A, B;

FIG. 5F is a further embodiment of the leads of FIGS. 2A, B;

FIG. 5G is a further embodiment of the leads of FIGS. 2A, B;

FIG. 5H is an of the lead status of the leads of FIGS. 2A, B;

FIG. 6 is a block diagram of an example-computing device of the system of FIG. 1;

FIG. 7 is a further example of the consolidation engine of the environment of FIG. 1;

FIG. 8A shows an example lead capture operation of the consolidation engine of FIG. 1;

FIG. 8B shows a further example lead capture operation of the consolidation engine of FIG. 1;

FIG. 8C shows a further example lead capture operation of the consolidation engine of FIG. 1;

FIG. 8D shows a further example lead capture operation of the consolidation engine of FIG. 1;

FIG. 8E shows a further example lead capture operation of the consolidation engine of FIG. 1;

FIG. 9 provides a block diagram of lead follow-up tools of the environment of FIG. 1;

FIG. 10 is an example report generation process of the environment of FIG. 1;

FIG. 11A is an example report generated by the process of FIG. 10;

FIG. 11B is a further example report of FIG. 11A;

FIG. 11C is a further example report of FIG. 11A;

FIG. 11D is a further example report of FIG. 11A;

FIG. 11E is a further example report of FIG. 11A;

FIG. 12 is a further example report generation process of the environment of FIG. 1;

FIG. 13 is a further example report generation process of the environment of FIG. 1;

FIG. 14 is an example view of the messaging interface of FIG. 9;

FIG. 15 is a further example view of the messaging interface of FIG. 9;

FIG. 16 is a further example view of the messaging interface of FIG. 9;

FIG. 17A is a further example view of the messaging interface of FIG. 9;

FIG. 17B is a further example view of the messaging interface of FIG. 9;

FIG. 17C is a further example view of the messaging interface of FIG. 9;

FIG. 17D is a further example view of the messaging interface of FIG. 9;

FIG. 17E is a further example view of the messaging interface of FIG. 9;

FIG. 18 is a further example view of the messaging interface of FIG. 9;

FIG. 19 is an example view of a search result of the tools of FIG. 9;

FIG. 20A is an example view of sticker data of the tools of FIG. 9;

FIG. 20B is a further example view of FIG. 20A;

FIG. 21 is a further example view of the messaging interface of FIG. 9;

FIG. 22 is a further example view of the messaging interface of FIG. 9;

FIG. 23 is an example template of the tools of FIG. 9;

FIG. 24 is a further example template of the tools of FIG. 9;

FIG. 25 is a further example template of the tools of FIG. 9;

FIG. 26 is an example operation of the environment of FIG. 1;

FIG. 27 is an example response message of the engine of FIG. 4; and

FIG. 28 is a further example response message of FIG. 4.

### DETAILED DESCRIPTION OF EMBODIMENTS

### Lead Distribution Environment 100

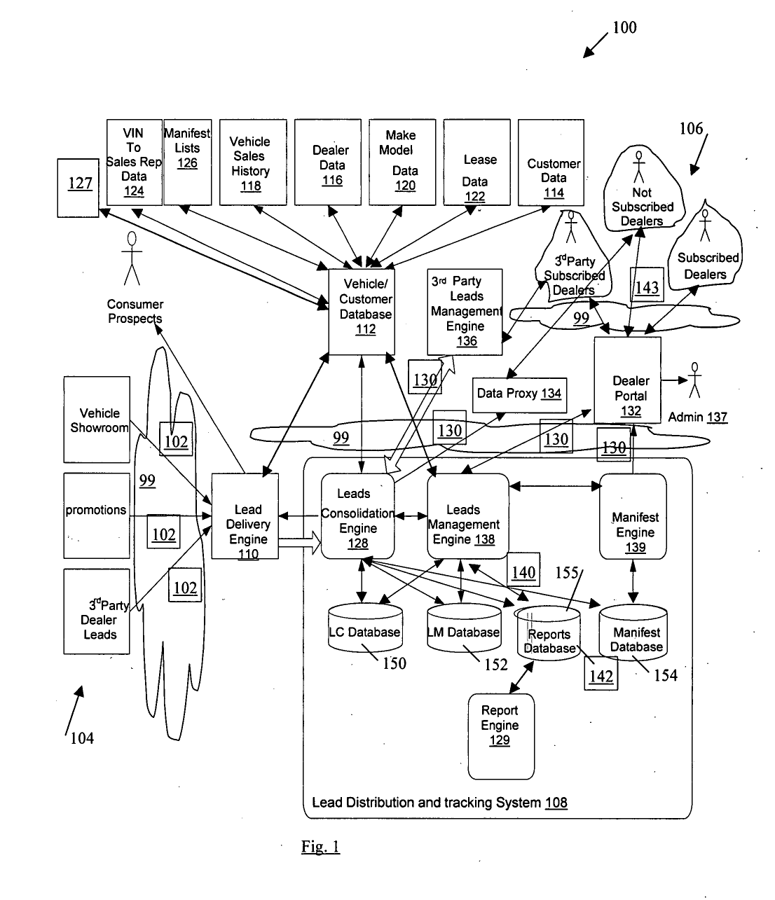

Referring to FIG. 1, shown is a lead management environment 100 that captures, qualifies (through value added association of data to initial leads 102) and distributes leads 102 from several sources 104 to car dealerships 106 over one or more communication networks 99, for subsequent lead 102 follow-up by users of the dealerships 106, as further described below. The leads 102 can be pre-processed into available leads 130, which are then accessible to the dealers 106 via various network mechanisms, such as but not limited to a dealer portal/gateway 132, a data proxy server 134 (a message distribution service that can facilitate outbound messages are not labelled as SPAM by network ISPs and/or system firewalls), and/or one or more third party lead management engines 136. In the environment 100, there can be different classifications of the dealers 106 for the purpose of lead management. For example, the dealers 106 can be such as but not limited to: users who subscribe to a lead management engine 138 and receive their leads 102, 130 directly; organizations that use a 3rd Party Lead Management system 136 and can receive their leads 102,130 from the system 108 for importing into their own system; and unregistered dealers 106 that do not have or use the Lead Management engines 136,138 and can receive leads 102, 130 in the form of a network communication (e.g. an e-mail), further described below. The system 108 information can also be accessed/configured by one or more system administrators 137 (e.g. of the vehicle manufacturer and/or dealership 106).

The leads 102 are collected through a lead delivery engine 110 to a centralized lead distribution and tracking system 108. The system 108 has access to data 112 (e.g. corporate data collected by the vehicle manufacturer) including information such as but not limited to: existing customers 114 (names, customer IDs, addresses, contact information, and other information specific to the customers); dealers 116 (e.g. including available vehicle service history and/or maintenance schedule data from the On-Star™ system data collected from vehicle onboard computers); vehicle particulars (previously purchased vehicle data 118 that is associated with the respective customer and/or dealer information, current vehicle inventory 120 by the manufacturer and/or on a dealer by dealer basis, vehicle finance/lease data 122 that is associated with the respective customer and/or dealer information, and VIN data 124); manifest data 126, and third party data 127 (e.g. socio-economic data, rewards programs data, etc.), for example. Accordingly, it is recognized that the data 112 includes information that is associated with individuals (e.g. potential customers), existing customers, and/or dealerships. It is recognised that the lead delivery engine 110 could also access the data 112 in delivery of leads 102 relating to vehicle lease termination information from the lease data 122 and prospective customers from the manifest lists 126. Further, it is recognised that the lease data 122 and manifest lists 126 information could be transmitted directly to a leads consolidation engine 128 for subsequent leads processing (e.g. facilitating the process of turning the leads 102 into the available leads 130), as further described below. In any event, it is recognised that the system 108 imports the leads 102, processes and cleans the leads and then distributes the now available leads 130 to the appropriate dealer 106 location, as well as manages and reports on the leads 130 and any activities that are assigned each business opportunity (e.g. leads 130) known to the system 108.

It is recognised that the data 112 (e.g. Sales History, Dealer Data, Make/Model Master File data, VIN to Sales Rep. Data, and/or Manifest Lists) can also be imported into the system 108 in order to associate incoming leads 102 data with static information (e.g. known to the manufacturer and/or respective dealers 106). The data 112 can be imported into the system 108 in to the appropriate memory (e.g. LC database 150, LM database 152, manifest database 154) and can be updated by the system 108, in communication with the database 112, on a regular/periodic basis.

Referring again to FIG. 1, the system 108 also has a leads management engine 138 and a manifest engine 139, either/both usable for turning the captured leads 102 into the available leads 130. The management engine 138 also facilitates the collection of feedback data 140 from the dealers 106 relating to the manner in which the dealers 106 processed the leads 102,130. The feedback data 140 is used in generation of reports 142 that can be requested/accessed by the dealers 106 as well as by the vehicle manufacturer 137 (e.g. through the dealer portal 132). The reports 142 can be configured on a division(s), brand team(s), field organization(s), retail dealer(s), and/or sales person(s) basis, for example.

### System 108 Overview

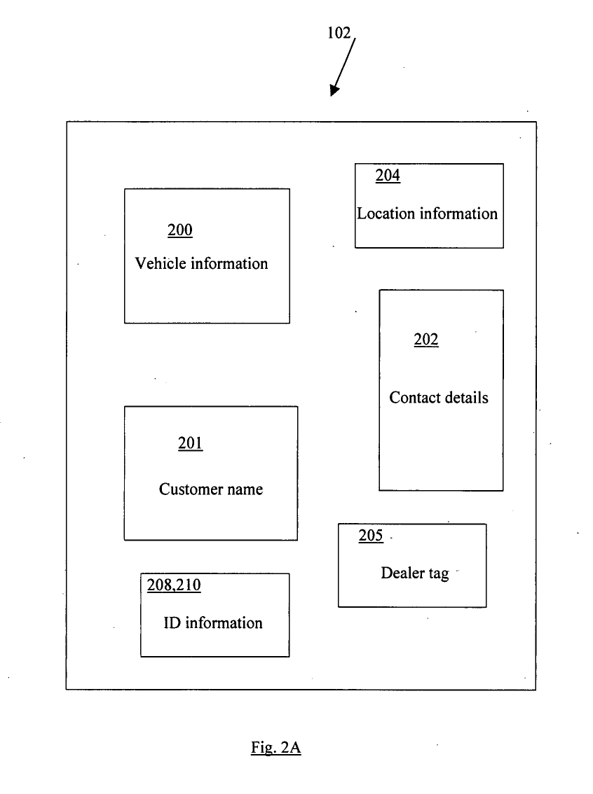

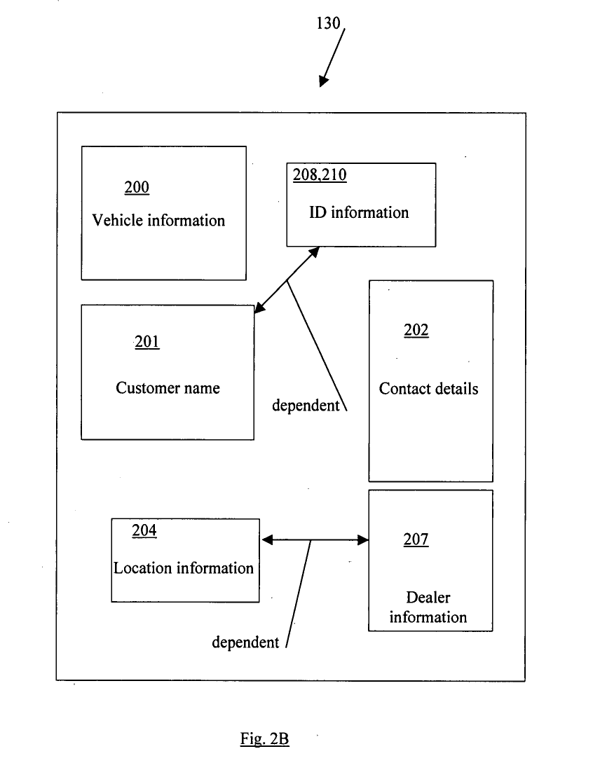

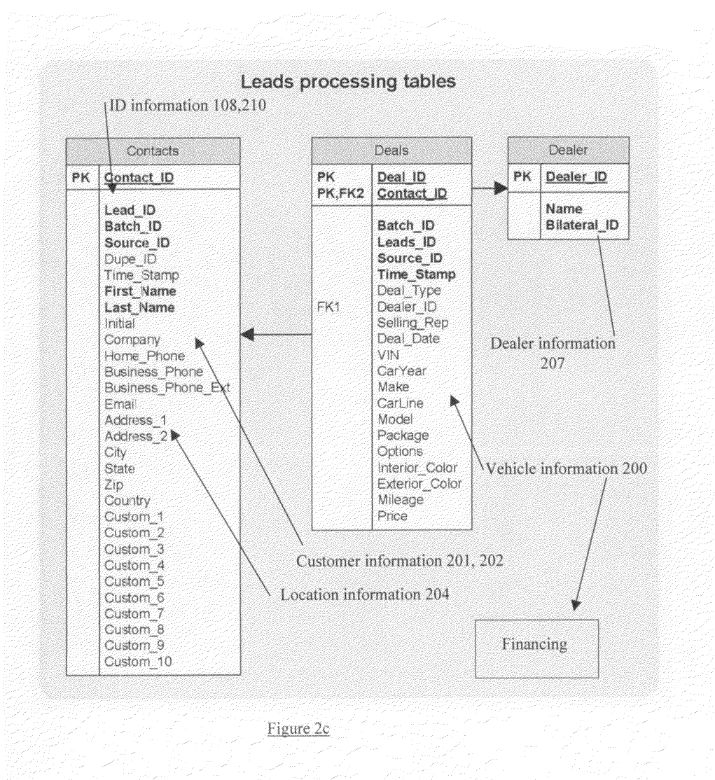

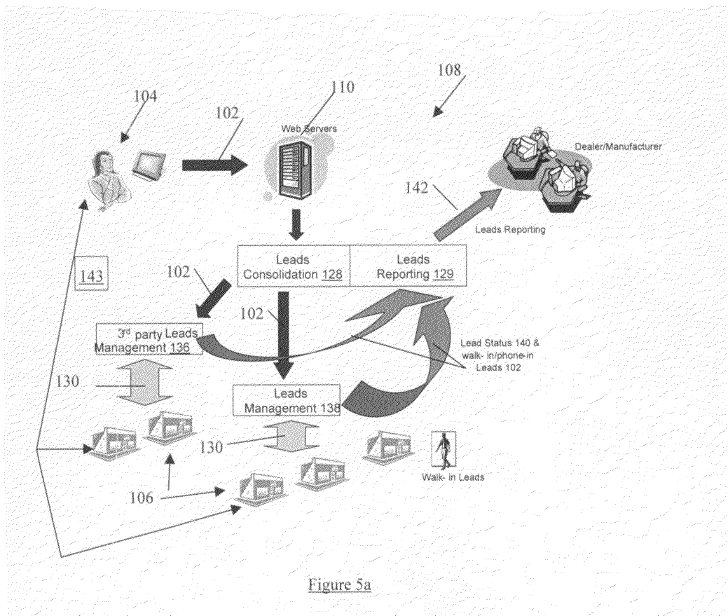

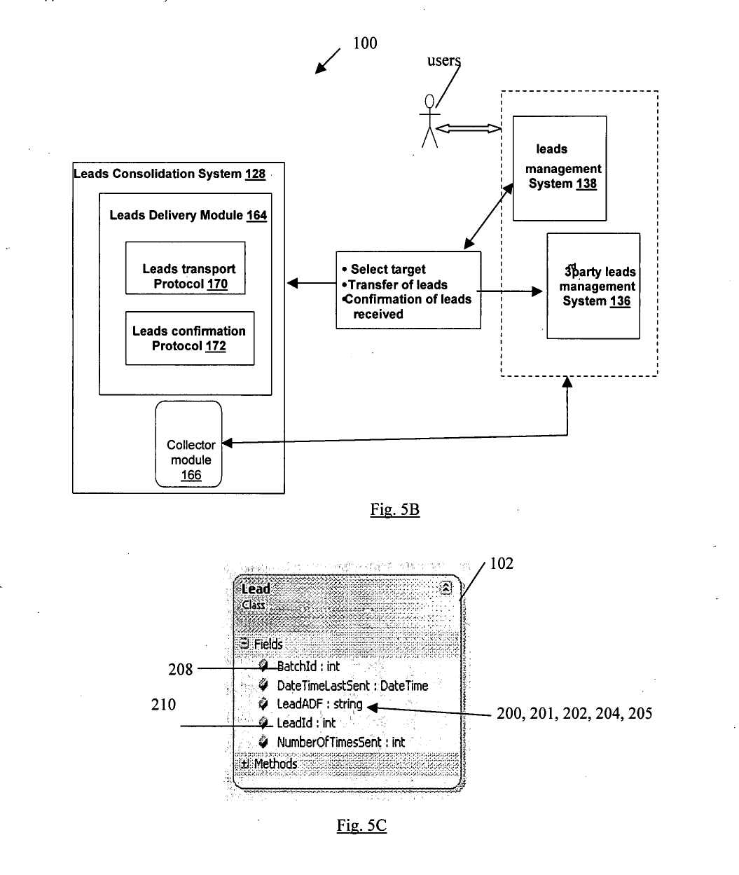

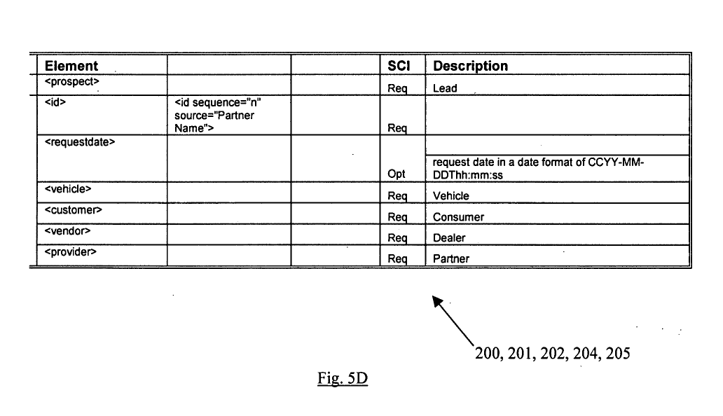

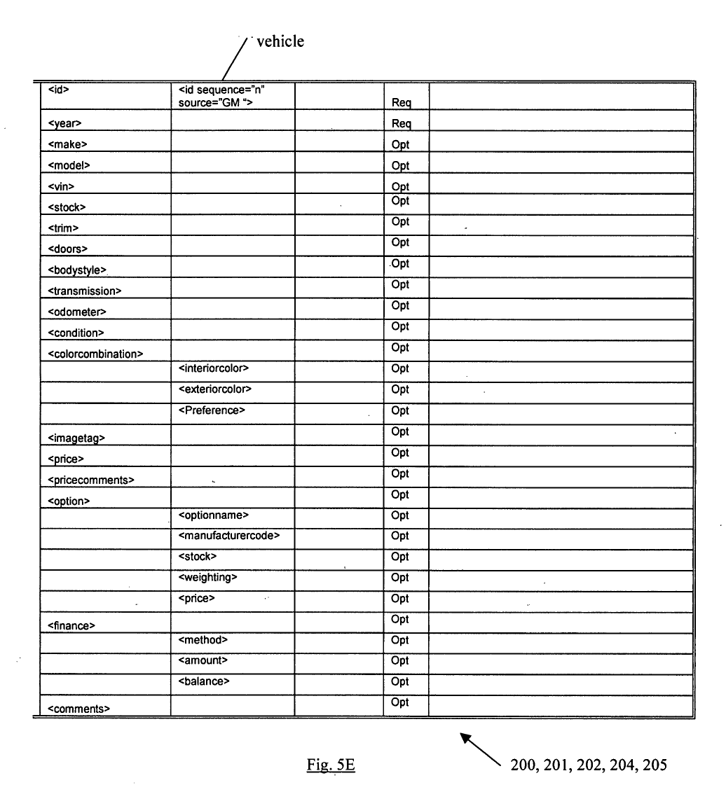

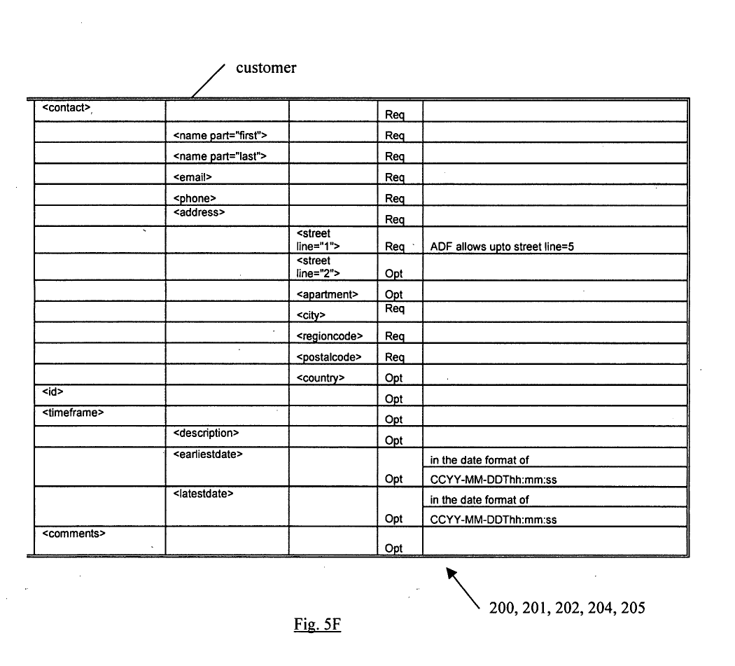

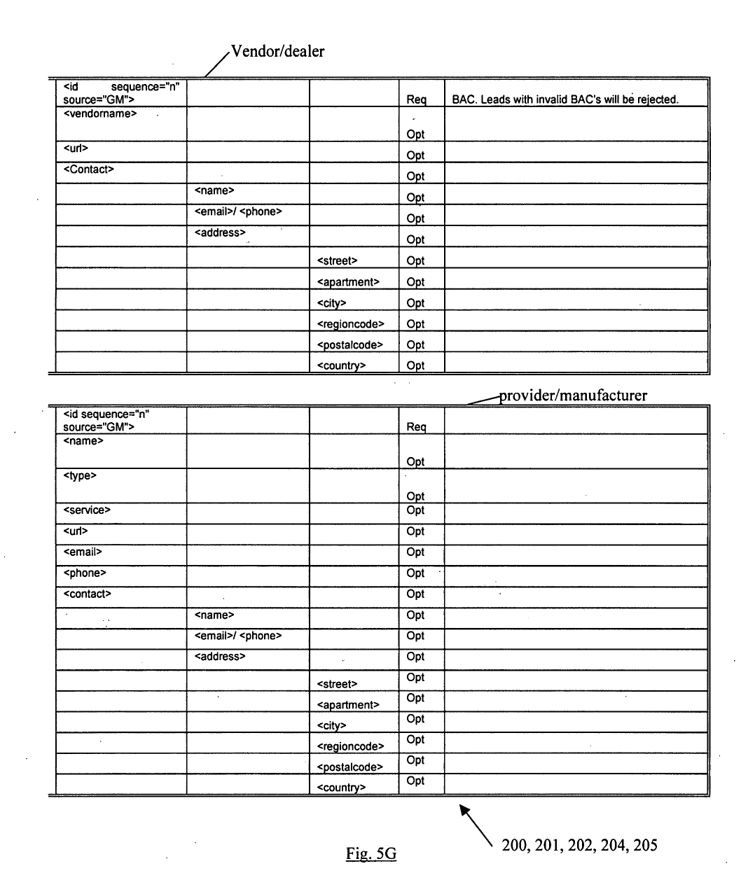

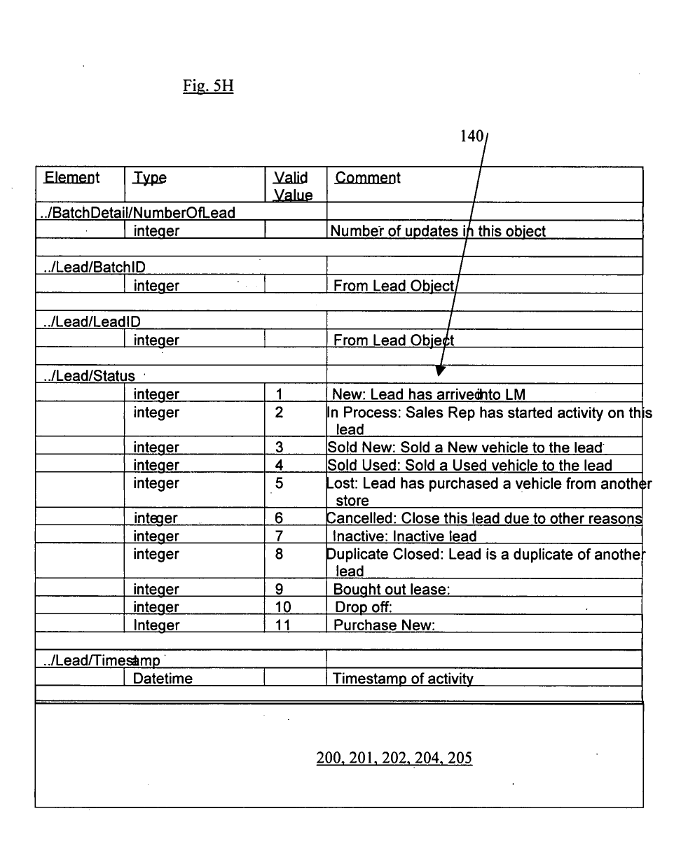

Referring to FIG. 5a, shown is an overview of the leads consolidation 128 and reporting 129 engine context, which consolidate all leads 102 and distribute those leads 102 to the targeted Leads Management engine 138 and/or the certified 3rd party Leads Management engines 136, based on location information 204 (see FIG. 2A) contained in the lead 102 when obtained from the source 104. It is recognised that the engines 136, 138 are associated with one or more respective dealerships 106 with a location that matches the location information 204 of the original lead 102 (e.g. a vehicle request of a customer located in the east end of a metropolitan area would be distributed as a lead 102 to the dealership 106 also located in the vicinity of the east end of the metropolitan area), each of the dealers 106 having users (e.g. sales associates) configured through the system 108 to follow-up the lead 102, 130. The engines 136, 138 facilitate processing of the lead 102, once received from the leads consolidation engine 128, into the available leads 130 through the association/matching of the data 112 (containing customer specific data such as vehicle purchasing and/or leasing history) with the customer information of the leads 102, further described below. The association of the data 112 with the leads 102 helps to generate a higher quality lead 130 by providing the end user (e.g. dealer 106) with more relevant information concerning the vehicle and customer data of the lead 102, for example. The engines 136, 138 are configured to report back to the leads consolidation engine 128 the lead status 140 of each lead 102, as well as to report back walk-in or phone-in traffic leads (e.g. dealer 106 generated leads 102).

Initially, leads 102 from consumers (e.g. from the various sources 104) are passed to the leads delivery engine 110 and then to the leads consolidation engine 128. The leads consolidation engine 128 prepares the lead 102 (communicated as either a single lead or as a batch/group of leads) for distribution, and sends the lead(s) to the appropriate/targeted LM engine(s) 136,138. Further, it is recognised that changes to the data 112, based on the results of the leads 130, (e.g. vehicle sold by dealer X) can be sent by the engine 128 back to the database 112 for updating purposes of the corporate data, for use in analysis/matching with any subsequent leads 102 by the engines 136, 138.

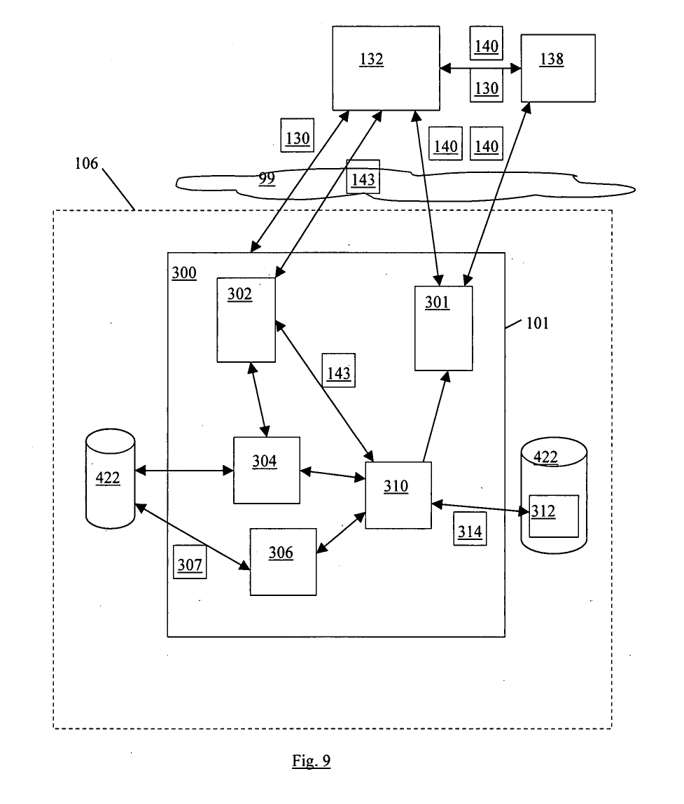

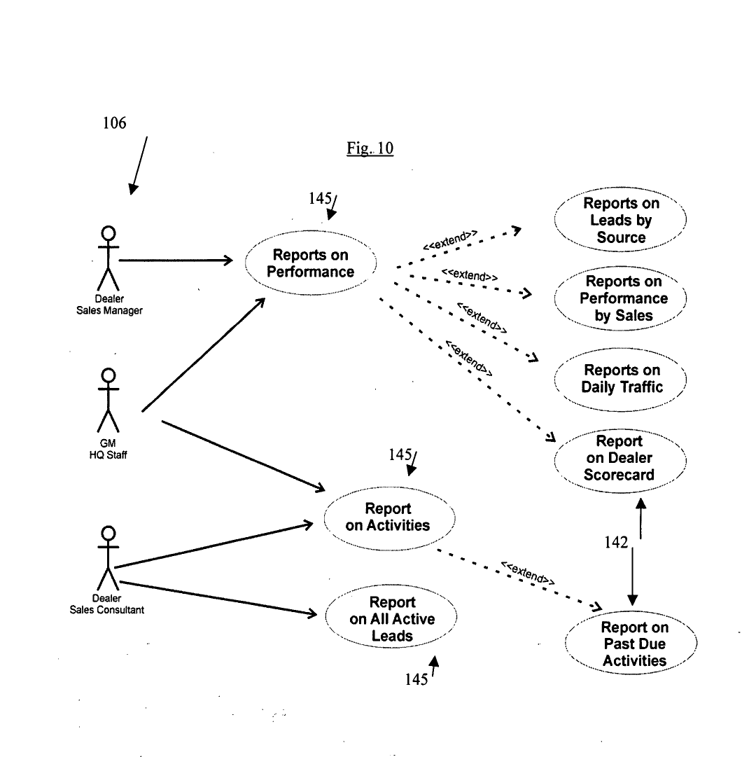

The LM engine(s) 136,138 receive their respective leads 102 from the leads consolidation engine 128 and present the associated available leads 130 to the appropriate sales person (e.g. dealer user) at the dealership 106, e.g. via the message interface 302 (see FIG. 9) coupled to the dealer portal 132 (see FIG. 1). The LM engine(s) 136,138 monitor the sales person's activity (e.g. response/quotation messages 143 to the customer of the leads 130) with each of the leads 130 and report to the leads reporting engine 129 the progress/status of the leads 130. The leads reporting engine 129 generates the reports 142 as programmed or otherwise requested by the dealer/manufacturer operations overseeing the leads 130.

Referring to FIG. 5b, shown are further details of the leads consolidation engine 128, including a Leads Delivery module 164 and a Lead Throwback collector module 166. The leads delivery module 164 coordinates the delivery of the leads 102 to the appropriate/targeted Leads Management engine(s) 136,138. After the leads 102 are processed and marked as deliverable by the leads consolidation engine 128, the leads processing module 164 deposits the leads 102 into the leads bucket/queue (implemented by a leads transport protocol 170) for the targeted LM engine(s) 136,138 associated with the dealership 106 selected for the leads 102 (i.e. through the location information 204—see FIG. 9). The leads delivery module 164 then communicates the leads 102 over the network 99 to the corresponding LM engine 136,138, e.g. using an ADF format or other defined format. The LD 164 module can govern the frequency for leads 102 delivery to the targeted LM engine 136,138. For example, the leads delivery module 164 on average can deliver every 15 to 20 seconds within 3 minutes (a defined maximum lead delivery lag time after receipt by the leads consolidation engine 128 from the sources 104) depending on the amount of traffic destined for the targeted leads management engine 136,138.

Referring again to FIG. 5b and to FIG. 5c, each lead 102 undergoes the following events, for example:

1. the leads consolidation engine 128 processes the lead 102 and marks it deliverable;

2. the LD module 164 selects a target LM engine 136,138 based on the location information 204 (see FIG. 9) that matches the dealership 106 associated with the target LM engine 136,138;

3. the LD module 164 selects a number of leads 102 associated with the target LM engine 136,138, if applicable, for a batch transmission of the leads 102;

4. an LD transport protocol 170 wraps the lead information 200, 201, 202, 204, 205 along with additional identification fields (Batch ID 208, Lead ID 210, etc . . . ) into a lead 102 network message, such that the batch and/or lead IDs are used to uniquely identify each of the leads 102;

5. the LD module 164 delivers (e.g. via a synchronous or asynchronous communication) the leads 102 via the transport protocol 170 (e.g. web service) to the targeted LM engine 136,138; and

6. the target LM engine 136,138 indicates via a confirmation protocol LD 172 a successful transmission of the lead 102 network message.

For example, the Leads transfer protocol 170 can be implemented as a hosted SSL-secured web service that accepts leads 102 data. In order for delivery of the leads 102 to be successful, each LM engine 136,138 provides a single target location (e.g. specifying the URL—network 99 address—of the LM engine 136,138) associated with specific dealership(s) 106, to which the leads 102 will be delivered. Delivery can be performed over SSL to facilitate secure transport from the leads consolidation engine 128 to the target location. Further, in addition to the transport of leads 102, the lead delivery module 164 expects the target LM engine 136,138 to return lead arrival confirmation as part of the leads confirmation protocol 172. If an arrival confirmation is not received from the LM engine 136,138 for a given lead 102, the lead 102 will remain in the delivery queue for additional resend attempts.

Referring to FIGS. 5ci, 5cii, 5ciii, 5civ, shown are examples of the vehicle and customer information 200, 201, 202, 204, 205 fields contained in the lead 102, 130. It is recognised that not all of the fields may be filled by the initial lead 102 information obtained from the source 104 and the processing completed by the leads consolidation engine 128. Accordingly, the LM engine 136,138 can facilitate further processing of the leads 102, through access to the data 112 (either locally or remotely) for generating the available leads 130 that are made available to the users of the dealerships 106, as further described below.

Referring again to FIG. 5b and to FIG. 5d, the Lead Throwback Collector module 166 collects all feedback data 140 from the LM engines 136,138. The feedback data 140 can have a number of status codes (e.g. New: Lead has arrived into LM, In Process: Sales Rep has started activity on this lead, Sold New: Sold a New vehicle to the lead, Sold Used: Sold a Used vehicle to the lead, Lost: Lead has purchased a vehicle from another store, Cancelled: Close this lead due to other reasons, Inactive: Inactive lead, Duplicate Closed: Lead is a duplicate of another lead, Bought out lease, Drop off: Purchase New), as desired, each of the lead statuses being associated with the respective batch and/or lead IDs 208, 210—see FIG. 5c). The network 99 interface to this collector module 166 can be through a secure FTP (FTPS over SSL) site, which can be accessed by pre-approved vendors. Feedback data files 140 uploaded/downloaded to collector module 166 can be in a number of different formats, e.g. one format for new leads (containing the new lead tag 205—see FIG. 2a) and another for status updates for existing leads 102. Processing on the feedback data 140 can be conducted in a nightly batch process, as desired.

The Lead Throwback module 166 facilitates the performance of lead 102 management and status tracking. These lead management and status tracking activities of the dealerships 106 are reported back to the system 108 through the lead collector module 166. Based on data sharing agreements, dealer leads (such as walk in leads) can also be thrown back to system 108 for a consolidated strategy. The flow for this throwback process can be as follows, for example:

1. the sales rep of the dealership 106 performs leads activities, generating status changes to the received leads 102 by the dealership 106;

2. any lead that is inactive is flagged by the information 140, such that the definition of inactive can be any lead 102 that has no status change in for a predetermined threshold (e.g. 30 days) and the next action date is less than current date;

3. on a scheduled basis, e.g. at every 24 hours, the any lead that changed status since the last throwback is flagged, as well as all new leads entered into the system since the last throwback. The new status and the new leads can be thrown back to module 166 using different file formats;

4. the system gathers the new leads and generates a corresponding new lead file;

5. the system gathers the status changes and generates a status change file including the batch and/or lead IDs for reconciliation/matching of the feedback data 140 with the original leads 102 containing the same IDs;

6. this SCI throwback format file data 140 is uploaded to the Leads Collector module 166 (e.g. via secure FTP at a scheduled time);

7. the leads consolidation engine 128 processes the data 140, in case where no lead status or no lead throwback data 140 are available, a file with 0 leads status can be expected, just to confirm that there are no leads status changes available, but that communication is successful; and

8. The leads consolidation engine 128 can notify the data 140 sender of any problems with the Statuses or New Leads files data 140 thrown back via a network 99 message (e.g. an email).

### Data 112

It is recognized that the system 108 is uniquely designed to provide two layers of functionality with respect to the concept of data 112. It is recognized that the data 112 can be situated on a number of disparate systems and can be represented as static data as well as the data value result of functionality (e.g. algorithms) provided by the each of the disparate systems. For example, in the event that data is required by the system 108 to complete a request, the system 108 can access any of the physical data and/or provide input to function calls, in order to obtain the data set needed to satisfy the request. It is recognized that the access to the data and/or the functions (through function calls) can be distributed across the disparate systems (e.g. 114,116,118,120,122,124,126,127).

The first layer of functionality is that the system 108 serves as a “data and integration layer” that creates an infrastructure that knits together “islands of data and functionality that exist in legacy systems in our customers” (e.g. dealerships, manufacturers) enterprises. This layer builds and offers our customers a single consolidated view of customer and vehicle data by assembling and linking the fragments of data that exist in the legacy “islands”. This capability also allows cleanup of existing data stores in legacy systems and speeds the update of these systems by “de-duping” data, highlighting data discrepancies and “cascading updates captured in one “island” through the entire enterprise (for example a change of address for a customer captured in a finance system can be “cascaded” through our solution to update the customer address information in all other connected disparate systems that contain customer name and address information, based on defined patent/child relationships between the systems and update data. This layer also allows a user access to the functionality contained in each of the legacy “islands” through our common portal 132 thereby creating a single unified process flow for users. This gives them access to both data and functionality previously only available by accessing multiple disconnected systems. Specifically, all of the functionality required to handle a customer lead, deal with a customer in the showroom, handle a trade-in, locate, price, finance and sell a new vehicle can be available through our portal interface 132, one way in which to access the system 108. This can save time, improves the customer experience and reduce errors associated with the maintenance and manual updating of multiple disconnected systems.

The second layer of our system 108 provides application level functionality in addition to functionality previously available through stand-alone applications available to our customers. The functionality is superior for two main reasons. The first is that value associated with functionality can be expressed as: VALUE=FUNCTION+CONTENT, our data and integration layer described above provides “content” to our applications not available to stand-alone applications used previously or currently available to our customers. The second reason is that the “functionality” we have built into our applications is unique in a number of ways, e.g. through implementation, for example, of the engines 110,128,129,136,138,139, tools 300, messaging interface 302, and portal 132, as described below by example.

### Network 99 Communications

Referring to FIG. 1, the transmission protocols/formats and acknowledgement formats (e.g. XML or other structured definition language defined protocols/formats) of the leads 102,130 messages, dealer response 143 messages, feedback data 140, and reports 142 are defined for the network 99 communications between the dealerships 106, the sources 104, and the system 108. For example, the network communications can include communication protocols such as but not limited to: SSL—Secured Socket Layer; SOAP—(Simple Object Access Protocol); HTTP—Hypertext Transfer Protocol; HTTPS—Hypertext Transfer Protocol Secure; POP3; and Secure FTP.

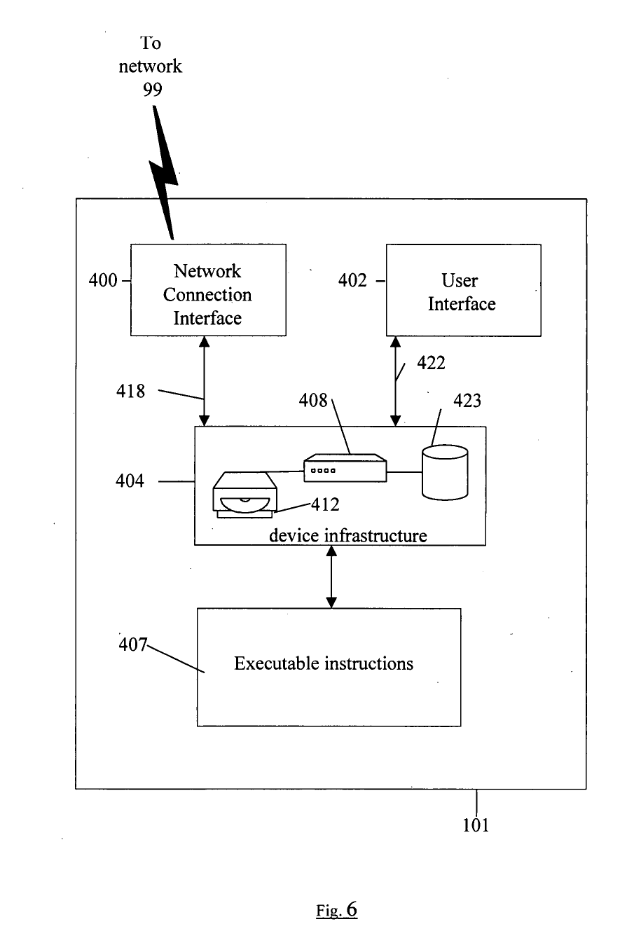

As shown in FIG. 26, to access the lead 130 messages, the user of the dealership 106 goes to the message interface of the portal 132 (see FIG. 1) and signs in (e.g. provides user name and password), for example via a network browser 407 (e.g. included in the executable instructions 407 of the user device 101—see FIG. 6). Preferably, once signed on, the user has access to the respective leads management engine 136,138 and associated leads 130 including functions such as but not limited to: searching of the LM databases 22 (e.g. for messages relating to the user assigned leads 130 and/or for vehicle/customer information in working of the lead 130); report 142 request/generation; and any applicable administrative functions.

Referring to FIG. 1, the message interface of the portal 132 can be represented as transaction client(s) in communication with a transaction server, namely the system 108 (e.g. engines 128, 129 and/or 136,138), hence a client-server relationship for communication of the leads 102,130 messages, dealer response 143 messages, feedback data 140, and reports 142. Further, it is recognised that the system 108 can be configured as a back-end system of the dealerships 106. For example, it is recognised that the system 108 can be configured as a web service(s) and/or other services such as but not limited to SQL Databases, IDL-based CORBA and RMI/IIOP systems, Legacy Databases, J2EE, SAP RFCs, and COM/DCOM components. The web service(s) can be defined as a software service, which can implement a network 99 communication interface such as expressed using Web Services Description Language (WSDL) registered in Universal Discovery Description and Integration (UDDI) in a web services registry, and can communicate through defined network 99 messaging by being exposed over the network 99 through an appropriate protocol, such as the Simple Object Access Protocol (SOAP). In some implementations, SOAP is a specification that defines the XML format for the network messaging, including a well-formed XML fragment enclosed in SOAP elements. SOAP also supports document style applications where the SOAP message is a wrapper around an XML document. A further optional part of SOAP defines the HTTP binding (i.e. header), whereas some SOAP implementations support MSMQ, MQ Series, SMTP, or TCP/IP transport protocols. Alternatively, the system 108 and associated dealer 106 systems may use other known communication protocols, message formats, and the interface may be expressed in other web services languages than described above.

In view of the above, it is recognised that the functionality of the system 108 can be represented to the dealerships 106 as a Web service. Further, it is recognised that the lead delivery engine 110 can be represented to the sources 104 as a web service or other network 99 communications interface, as desired. Further, Web services can be Web APIs that can be accessed over the network 99 and executed on the remote device 101 hosting the requested services. The Web service definition can encompass many different systems, but can refer to clients and servers that communicate XML messages that follow the SOAP-standard, via a description of the operations supported by the server, e.g. in WSDL.

Web content provided by the Web services can be referred to as textual, visual or aural content that is encountered as part of the user experience through interaction with Web sites/services. Web content may include, among other things: text; images; sounds; videos; animations; and feeds (video, audio, and/or textual). For example, the pages can present content as predominantly composed of HTML, or some variation, as well as data, applications, e-services, images (graphics), audio and video files, personal Web pages, stored/available e-mail/network messages, etc.

It is recognised that in general, a network 99 message is information which is sent from a source to a receiver. In network 99 messaging, which is the formal exchange of event notification, requests, or replies between programs through a network 99 messaging protocol, the network 99 message is data in a specified format that describes an event, a request, or a reply between programs. The network 99 messages can contain record information, such as a stream of data expressed in plain or encrypted language (notation) and prepared in a format specified for intended transmission by a telecommunications system (e.g. device 101—see FIG. 6) connected to the network 99. One example of network 99 messages is instant messaging, whereby an instant messaging client connects to an instant messaging service. Instant messaging differs from e-mail in that network 99 communications happen in real-time between message senders/recipients.

A further example of network 99 messages E-mail (electronic mail), which is the exchange of computer-stored messages (message text and/or message attachments—e.g. documents, images, etc.) by telecommunication. E-mail messages are usually encoded in ASCII text, with the inclusion of non-text files, such as graphic images and sound files, as attachments sent in binary streams. E-mail is one of the protocols included with the Transport Control Protocol/Internet Protocol (TCP/IP) suite of protocols. A popular protocol for sending e-mail is Simple Mail Transfer Protocol and a protocol for receiving it is POP3.

In general, it is recognised that the environment 100 can include a plurality (not shown) of systems 108 and associated engines 110, such that the portal 132, data proxy 134, and/or third party management engines 136 provide an entry point to the data stored in the databases 150, 152, 154, 155, including for example the leads 130. It is also recognised that the engines 128, 129, 136, 138, 139 can be hosted on the same or different devices 101 (see FIG. 6), as desired. For example, the engine 136,138 could be hosted locally by the dealerships 106 and communicate remotely over the network 99 with the engines 128,129, as desired.

### Lead Sources 104

It is recognised that the leads 102 can be communicated over the network 99 to the delivery engine 110 from various sources 104. The leads 102 can be communicated as a group of leads 102 (e.g. batch leads 102) or as individual leads 102 (e.g. real time enquiry via the manufacturer's Web site).

The following are examples of lead sources 104, such as but not limited to:

1) finance/leasing leads through lease information 122 of leased vehicles (e.g. relating to upcoming lease expiries);

2) manufacturer Web site data (e.g. on-line vehicle virtual showrooms and other third party car information Web sites);

3) promotional data through which a consumer/contact has submitted an interest in purchasing a vehicle which can come from brochure requests, trade shows, special events, including direct marketing program data (also referred to as manifest lists) provided to the appropriate dealer 106 for dealer follow-up, which can include promotional codes for a sales campaign including campaign start and end dates, as well as business reply cards, call center contact inquiries, kiosks, Web requests, Internet Response Forms (IRF), auto shows, etc;

4) service leads due to scheduled maintenance, including vehicle condition/performance data collected from onboard vehicle computers; and

5) in-person visits of the customer to the physical dealer 106 showroom, or phone in directly to the dealer 106 or enquiries directly to the dealer 106 Web site, which can be further qualified as newspaper, radio, magazine, referral as the original source.

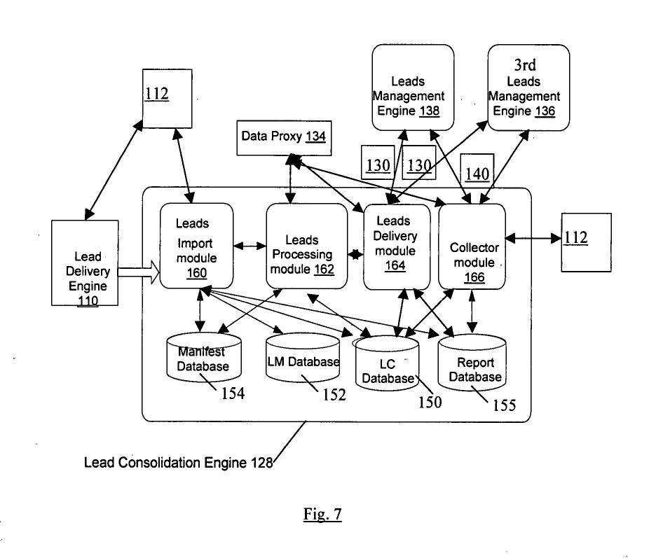

One of the lead sources 104 can be the manifest lists, which are related to customer marketing (e.g. direct marketing programs to consumers) and include targeted, unqualified prospects for each program. The manifest lists can be provided directly to the appropriate dealer 106 via a list for dealer analysis (e.g. identification and entry of leads 102 for receipt by the collector module 166—see FIG. 7) and follow-up, or can be provided as actual leads 130 by the engines 136,138 when the manifest lists are processed by the system 108. The marketing/manifest lists through Leads Management can allow the dealers 106 be able to perform manifest list functions including:

1. browse available manifest lists; and
2. go into a manifest list, click on a contact, and see the campaign data template for this marketing event. The campaign data template is a list of data fields available to track campaign data for each contact in a campaign. The engine 136,138 includes the capability for prospects within a marketing campaign (as identified by the dealer 106 from the manifest lists) to be directed into a lead activity bucket to become a lead 130, via upload/download to the collector module 166.

### Lead Content

Referring to FIG. 2A, the leads 102 contain a vehicle information/purchase request 200 (e.g. make, model, year) with contact details 202 (e.g. phone number, email/network address, etc.) of the customer. The customer contact details 202 can include a return network 99 address (e.g. email), with which the dealer 106 can reply to directly via a dealer device 101 (e.g. desktop, handheld, etc.). The lead 102 data can include a name 201 of the customer contact, the viable contact method/details 202 and location information 204 that allows the system 108 to identify which dealership 106 should be assigned the lead 102. The lead 102 also contains ID information 208,210 (e.g. batch ID, lead ID, source ID and other IDs) that can be used to uniquely identify the resultant available lead 130 for status and reporting functions, for example.

Referring to FIG. 2B, once processed by the leads management engine 136, 138, for example, the lead 102 is transformed into an available lead 130 to include further information such as but not limited to: dealer information 207 (e.g. the dealer location, contact details, specific user assigned to the lead, etc.). As further described below, the leads management engine 136, 138, for example, accesses the data 112 (locally or remotely) for supplementing the lead 102 information. Referring to FIG. 2c, shown is an example lead 130 with data fields defined for the information 200, 201, 202, 204, 205, 207, 208, 210.

It is recognised that each unique lead source 104 will be assigned a unique identifier (e.g. source ID) as well as the unique lead ID for each individual lead 102 that is generated. These ID(s) facilitate tracking of the leads 102 from source 104 to ultimate disposition and status for reporting or subsequent matching. Common lead 102 categorizations can include the following:
Source 104 of lead 102;
Lead 102 type; and
existing vs. new customer (include a unique consumer/customer ID assigned by the manufacturer via the data 112 for those customers identified as existing.

In the event that the customer is a new customer, the system 108 can generate a new unique consumer ID for each unique consumer lacking a manufacturer consumer ID. For example, ID assignment criteria can include criteria such as but not limited to: consumer last name and zip code; consumer last name and email; or consumer last name and phone number, before presenting potential matches for existing IDs or for the generation of new IDs.

Other lead content 102 can include data such as but not limited to:
Priority;
Lead initiation source 104 (each lead type could have multiple initiation sources 104 for the actual lead as pre-defined data elements, example a specific magazine ad or promotion);
Preferred dealership site (if any);
Preferred sale rep (if any);
Vehicle make;
Vehicle Carline;
Vehicle model;
Vehicle type;
Vehicle model year;
Customer location (e.g. zip code, city, state);
consumer/contact type such as employee, Supplier, fleet, commercial, retail consumer, etc; and
Date created.

### Devices 101

Referring to FIG. 6, a computing device 101 of the environment 100 can include a network connection interface 400, such as a network interface card or a modem, coupled via connection 418 to a device infrastructure 404. The connection interface 400 is connectable during operation of the devices 401 to the network 99 (e.g. an Intranet and/or an extranet such as the Internet), which enables the devices 101 to communicate with each other (e.g. that of the system 108, the lead delivery engine 110, the dealerships 106, the database 112, the portal 132, the data proxy 132, and any third party management engines 136) as appropriate. The network 99 can support the communication of the network messages for the various transmitted data (e.g. leads 102, leads 130, feedback data 140, reports 142, etc.).

Referring again to FIG. 6, the device 101 can also have a user interface 402, coupled to the device infrastructure 404 by connection 423, to interact with a user (e.g. dealer user, system 108 administrator, etc.). The user interface 402 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 404.

Referring again to FIG. 6, operation of the device 101 is facilitated by the device infrastructure 404. The device infrastructure 404 includes one or more computer processors 408 and can include an associated memory 422 (e.g. a random access memory). The memory 422 is used to store data (e.g. data 112, 150, 152, 154, 155) for access by the respective user and/or operating system/executable instructions 407 of the device 101. The computer processor 408 facilitates performance of the device 101 configured for the intended task (e.g. of the respective module(s) of tools 300—see FIG. 9, engines of the system 108, etc.) through operation of the network interface 400, the user interface 402 and other application programs/hardware 407 (e.g. browser or other device application on the mobile/desktop) of the device 101 by executing task related instructions. These task related instructions can be provided by an operating system, and/or software applications 407 located in the memory 422, and/or by operability that is configured into the electronic/digital circuitry of the processor(s) 408 designed to perform the specific task(s). Further, it is recognized that the device infrastructure 404 can include a computer readable storage medium 412 coupled to the processor 408 for providing instructions to the processor 408 and/or to load/update the instructions 407. The computer readable medium 412 can include hardware and/or software such as, by way of example only, magnetic disks, magnetic tape, optically readable medium such as CD/DVD ROMS, and memory cards. In each case, the computer readable medium 412 may take the form of a small disk, floppy diskette, cassette, hard disk drive, solid-state memory card, or RAM provided in the memory module 422. It should be noted that the above listed example computer readable mediums 412 can be used either alone or in combination.

Further, it is recognized that the computing device 101 can include the executable applications 407 comprising code or machine readable instructions for implementing predetermined functions/operations including those of an operating system and the system 108/tools 300 modules, for example. The processor 408 as used herein is a configured device and/or set of machine-readable instructions for performing operations as described by example above. As used herein, the processor 408 may comprise any one or combination of, hardware, firmware, and/or software. The processor 408 acts upon information by manipulating, analyzing, modifying, converting or transmitting information for use by an executable procedure or an information device, and/or by routing the information with respect to an output device. The processor 408 may use or comprise the capabilities of a controller or microprocessor, for example. Accordingly, any of the functionality of the executable instructions 407 (e.g. through modules associated with selected tasks) may be implemented in hardware, software or a combination of both. Accordingly, the use of a processor 408 as a device and/or as a set of machine-readable instructions is hereafter referred to generically as a processor/module for sake of simplicity. The memory 422 is used to store data locally as well as to facilitate access to remote data stored on other devices 101 connected to the network 99.

The data can be stored in a table, which can be generically referred to as a physical/logical representation of a data structure for providing a specialized format for organizing and storing the data. General data structure types can include types such as but not limited to an array, a file, a record, a table, a tree, and so on. In general, any data structure is designed to organize data to suit a specific purpose so that the data can be accessed and worked with in appropriate ways. In the context of the present environment 100, the data structure may be selected or otherwise designed to store data for the purpose of working on the data with various algorithms executed by components of the executable instructions, depending upon the application thereof for the respective device 101. It is recognised that the terminology of a table/database is interchangeable with that of a data structure with reference to the components of the environment 100.

### Lead Consolidation Engine 128

Referring to FIGS. 1 and 7, the leads consolidation engine 128 initially receives the leads 102 from various sources 104, where the lead data exists in electronic format in some manner associated with a particular customer in a particular location for a particular vehicle or set of vehicles. The leads consolidation engine 128 can load, format and standardize customer-provided lead 102 data, as well as walk in and phone up leads entered at dealership 106 (e.g. leads from the Dealer's Website, Dealer Purchased 3rd Party sources and leads manually entered by Dealer personnel). Once received, the leads 102 will be matched, de-duped and standardized as further described below. The leads consolidation engine 128 can consolidate leads 102 from all the disparate lead sources 104, using a leads import module 160 for receiving the leads 102 from the lead delivery engine 110, a leads processing module 162 for initial processing of the leads 102, a leads delivery module 164 for selecting the leads 102 for a targeted dealer 106 (via the dealer associated leads management engine 136,138), and a collector module 166 receives new leads 102 and existing lead 102 statuses from the leads management engines 136,138.

It is recognised that there can be a plurality of the engine 128 modules 160, 162, 164, 166 some of which are assigned to the import, processing and/or delivery of real-time leads 102 and others are assigned to the import, processing and/or delivery of batch leads 102. The use of designated modules 160, 162, 164, 166 based on lead processing priority can be used to help the efficient throughput of real-time leads 102, which can be useful in facilitating higher conversion rates of the real-time leads 102 based on increased response times by the dealers 106 (facilitated in part due to faster downloading of the real-time leads 102 to the engines 136, 138).

Further, it is recognized that any of the functionality of the engine 28,29,36,38,39 can be embodied by an appropriate module/processor, as desired.

### Leads Import Module 160

The Leads Import module 160 processes leads 102 and other data imported from various data sources 104. A lead 102 is categorized as either real time or batch. Real time leads can be embedded in ADF formatted emails (or other network messages) sent to the system 108 asynchronously, while batch leads can be embedded in text files and placed in an outbound queue of the lead delivery engine 110 for subsequent synchronous delivery. Non lead batch data can also placed in the outbound queue of the lead delivery engine 110. Whether the data to be transferred is real time or batch, emails or other network 99 messages can be sent to notify the system 108 that there is incoming data waiting to be processed. For example, real time leads (direct leads) can be such as but not limited to Internet leads and Batch leads can be such as but not limited to leasing leads, sales History leads, dealer entered data, and manifest lists.

An example implementation of the Leads Import module 160 is as follows. Using an Email Leads Watcher module, when an E-mail Lead e-mail is received a trigger is sent to an E-mail Leads module to begin processing the lead. These are arriving into a POP3 email service. E-mail Leads, when a trigger is received, the E-mail Leads module will load real time leads 102 into a Leads Import Bucket. The leads processing module 162 will subsequently process these leads 102 in the Leads Import Bucket. Inbound FTP module, when an FTP e-mail is received, indicating there are batch files waiting to be processed, the Inbound FTP module is triggered to: download batch files from the delivery engine 110 (e.g. a secure FTP server) based on the known filename; split the batch file up into the individual E-mails; insert a record in a Batch_Audit table with a time_stamp set to the date and time when the file is downloaded; extract and transform the file into multiple lead records and load them in the Leads Import Bucket; insert a record in a Leads_Audit_Detail table for each lead record; and invoke the appropriate download module for further processing (e.g. module 162). It is recognised that the module 160 can parse the received lead 102 message to determine its type (e.g. real-time or batch). In the case of real time leads, the module 160 loads the real time leads 102 in the Leads Import Bucket. In the case of batch lead files, the module can load the batch lead file in a message queue for processing as a priority second to any existing real time leads 102 and/or real time responses 143.

The module 160 can also assign/identify IDs (e.g. through an assignment module) as needed (e.g. batch IDs, Lead IDs, Source IDs, customer IDs). The assignment of the source 104 ID can be based on the message type of the lead 102, for example types such as but not limited to: Message; Quote Request; Duplicate Request; Accessory Request; Body Shop Request; Locate Vehicle; Parts Request; Finance Request; Service Request; Dealer-Locate; Quote Request; Test Drive; Used Request; promotions request; Schedule Test Drive; General Information Request; Hold & Schedule Test Drive; Price Quote; Test Drive; and Third Party Quote Request. It is recognised that the module 160 can also assign a processing priority to the lead 102 (e.g. urgent real time, within the hour, day or other specified response time, batch, etc.).

The module 160 can also have a tracking module for creating a report entry for tracking the lead 102 in the report DB 155, based on the ID of the lead 102 (e.g. lead ID). An example of the report entry is a record in a Leads_Audit_Detail table, for example.

### Leads Processing Module 162

The Leads Processing module 162 transforms data held in the Leads Import Bucket. The module 162 can standardize and de-dupe multiple leads from different sources 104, for the same customer, same dealership 106 using the entire database of previously processed leads 102. After the leads 102 have been transformed/processed, they are “clean” and ready for distribution to the engines 136,138. When the leads import module 160 puts leads in the Leads Import Bucket, it calls a stored procedure to insert records in a Restart table and fires up a Windows service, for example. The Windows service can in turn trigger the leads processing module 162 to perform functionality such as but not limited to: validate the leads 102; and notify the leads delivery module 164 that there are leads 102 to be distributed to the appropriate engine 136, 138.

There are a number of types of validation, such as but not limited to: address; Email/network address; telephone number; Zip code, postal code and other physical address information; dealer information; and de-duplication. The validation of leads 102 can be modular and configurable, i.e. the user can pick and choose what types of validation are to be performed based on the source 104 of the leads 102 and/or lead type. For instance, the user can specify leads from the Internet go through address and email validation. In addition, the user can also specify the level of validation, e.g. there can be 2 levels of email validation, the first level to check the syntax of the email address, while the second level to send an email to DNS to make sure it is a valid email address. Accordingly, if the lead 102 passes validation checks, the lead 102 will be deposited in the Leads Export Bucket to be picked up by leads delivery module 164.

The Leads Processing module 162, based on the types of validation required, will invoke the appropriate validation sub-modules to validate specific information of the leads 102, such as but not limited to: Hexillion—Email/message validation sub-module; Melissa—Address validation sub-module; and ThinData—Email/message transport validation sub-module (e.g. SOAP). Concerning address validation, the address validation sub-module validates address information of the leads, such as but not limited to: Country code; Region code; and Zip/Postal code. In addition, this sub-module can also check if there are: missing or multiple street numbers; missing or multiple unit numbers; missing or multiple cities; missing or multiple region codes; missing or multiple postal codes; and/or missing or multiple country codes, for example. Concerning email/message validation (e.g. Hexillion), the email/message validation sub-module calls the Hexillion service to validate the leads' 102 email/network 99 addresses. There can be different levels of checking, the first level is to make sure the syntax of the email address/network 99 is legal and the second level is to make sure the domain of the email/network 99 exists and has a network 99 address for receiving email.

Other validation procedures performed by the module 162 can include such as but not limited to: mandatory fields validation; telephone number validation; dealer ID validation; and de-duplication validation. Concerning telephone number validation, a telephone number sub-module can validate: telephone number and extension; as well as to check if there are missing or multiple phone numbers and missing or multiple extensions. Concerning dealer ID validation, this sub-module can check if the dealer ID of the leads 102 is a valid manufacturer (e.g. GM) dealer 106. Concerning de-duplication validation, this sub-module checks if the lead 102 being processed has no duplicates (e.g. by checking the lead 102 information 200, 201, 202, 204, 205, 207, 108, 210 with that of other existing leads 102 (in progress or completed). One form of duplication is that. the customer lead 102 is has already been assigned to another sales associate at the same dealership. A further validation is to check for the presence of lead data in mandatory data fields, such as but not limited to: BAC; Email, Vehicle Make, Vehicle Model, Name, Partner ID, and Partner Code for manufacturer Internet sources 104; BAC, Email or Phone or Mailing Address, Vehicle Lease Make, Vehicle Lease Model, Name, Residual, Term, Termination Date for financing/leasing sources 104; BAC, Email or phone, Name, Assigned Partner ID for third party sources 104; and BAC, Email or phone, Name for dealer lead sources 104 or other third party engines 136. It is also recognised that the module 162 can insert default data values into the lead 102 if missing (e.g. assume that the lead comes from the United States based on the presence of a US zip code).

If a match is found in duplicate validation then the lead will be flagged as a possible duplicate. Leads will not be rejected or eliminated as a result of possible duplication flagging. This flagging would be used for subsequent reporting to Customer as a way to help assess potential value of various lead sources. Leads that are flagged as possible duplicates will still be sent to the dealership by Supplier in the normal fashion. When a dealer reviews these leads they will easily be able to review all of the current leads for that customer and determine the best course of action to take with each lead.

### Leads Delivery Module 164

The leads delivery module 164 communicates the leads 102 to the targeted engine 136, 138. There can be a number of outbound traffic is by email/network messages, such as but not limited to: one is a lead(s) message is actual lead data; and two is a notification message of available leads data for downloading. The notification message can initiate an inbound request by the targeted engine 136,138 to an FTPS server of the system 108 and subsequent upload/download of the queued lead 102 data via FTPS, for example. For example, consumers of the Leads Delivery module 164 can be through a web service via HTTPS, such that the leads 102 are delivered via an XML SOAP envelope. In additional to delivering leads 102 via web services, the Leads Delivery module 164 can send leads 102 via email directly to those dealers 106 who choose not to subscribe to a Leads Management engine 136,138. It is also recognised that the module 164 can assign the lead 102 to a targeted dealership and/or sales associate/user (e.g. class of individual) of the dealership 106 based on a defined category of the lead 102, i.e. all leads of category 1 (e.g. vehicle type—luxury) go to sales associate 1, all leads 102 for category 2 (e.g. source type—leasing) go to sales associate 2; all leads 102 of category 3 (e.g. customer type—new purchaser from different dealership) go to the sales manager, etc. Accordingly, the categories can be defined based on parameters such as but not limited to: source; lead type; brand; model; purchasing history; and/or socio-economic factors.

The leads delivery module 164, once confirming a successful delivery of the lead data 102, registers the status of the delivered leads 102 as new in the database (e.g. report database 155) for subsequent action by the reports engine 129. Accordingly, the leads delivery module 164 can initiate the tracking process of the delivered leads 102 from the standpoint of the leads consolidation engine 128, i.e. the engine 128 expects feedback data 140 to be received from the engine 136,138 with respect to the delivered leads on a defined frequency basis (e.g. as defined in the various activities associated with the leads by the engine 136, 138), e.g. based on the report record entry in the DB 155 assigned to the lead 102,130 via the lead ID. In particular, the expectation of feedback data 140 receipt can be driven by the delivery date stamp of the leads 102. In any event, the engine 128 is configured to track any and all status changes of the delivered leads 102 (e.g. delivered to engine 136,138, pending at the dealership 106, in progress by the assigned sales associate, vehicle purchased, inactivated, vehicle leased, lead cancelled due to lost interest by customer, etc.).

It is recognised that the module 164 can also keep track of how many leads 102 have been sent to a targeted engine 136, 138 and are in process of follow-up, and can therefore select a different engine 136, 138 based on the number of leads 102. For example, the module 164 can keep track of the lead 102 status (e.g. new, in-progress) and therefore select other dealerships 106 and/or users al. the dealerships 106 to receive the lead 102, based on the lead throughput considerations and/or dealership follow-up performance, even though the secondary dealership 106 is further from the customer's physical location than the primary dealership 106.

### Collector Module 166

The collector module 166 collects leads 130 statuses from the engines 136,138. In addition to statuses, the Collector module 166 can also collect new lead 102 information generated by the dealers 106. This information (new lead and/or lead status) is stored as the feedback data 140 in the appropriate system database(s) (e.g. 150, 152, 154, and/or 155) for subsequent use in reporting and other aspects of lead generation, tracking/monitoring, and management. For example, the leads collector module 166 can depend on the engines 136, 138 to provide the feedback data 140 when available, can expect to receive the data 140 according to a predefined data reception schedule, and/or can prompt the engines 136,138 for communication of any data 140 currently available (e.g. to satisfy a report request external to the predefined schedule). In any event, the module 166 facilitates matching/storing of the feedback data 140 to the DB 155 report entry record(s) assigned to the lead 102,130 via the lead ID, for example.

### Example Lead Capture

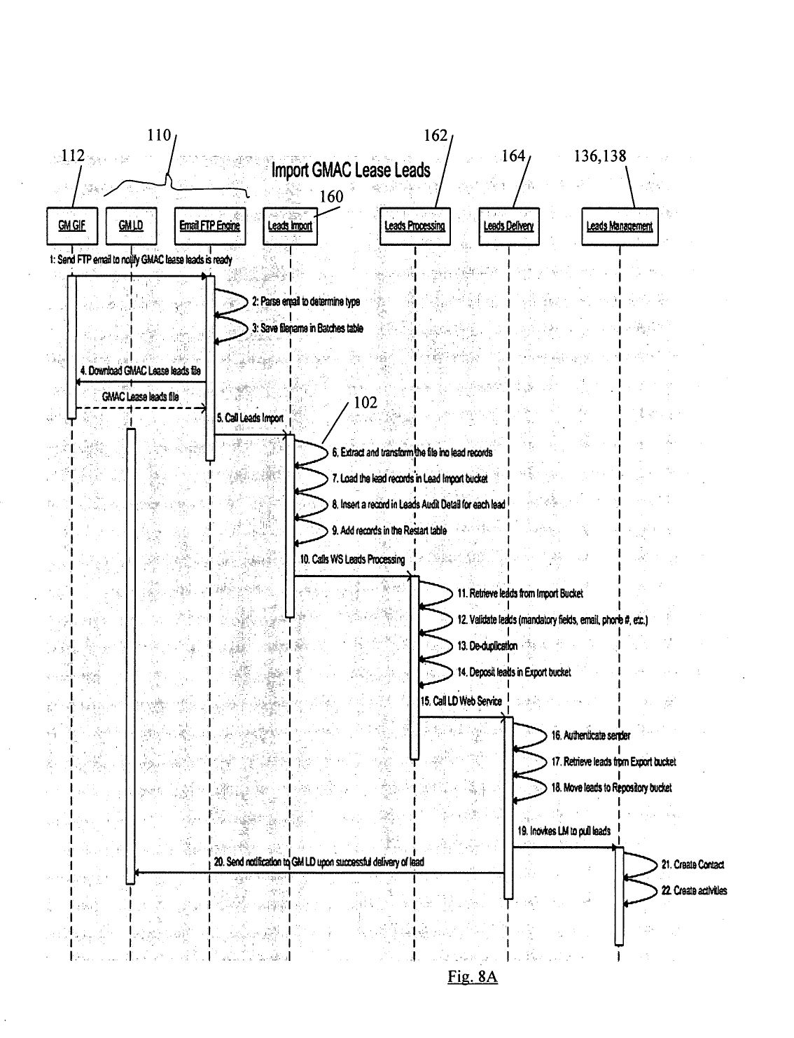

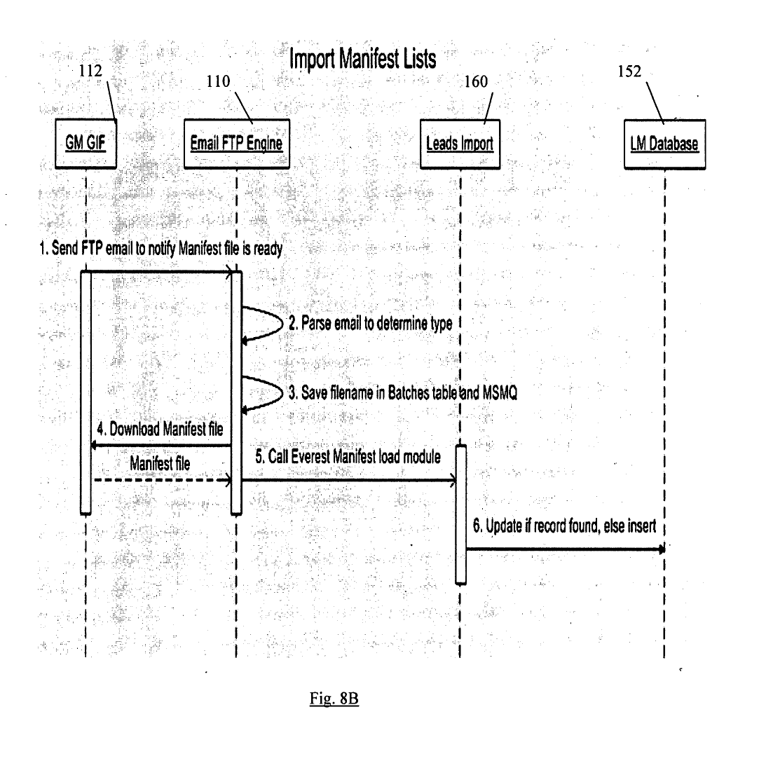

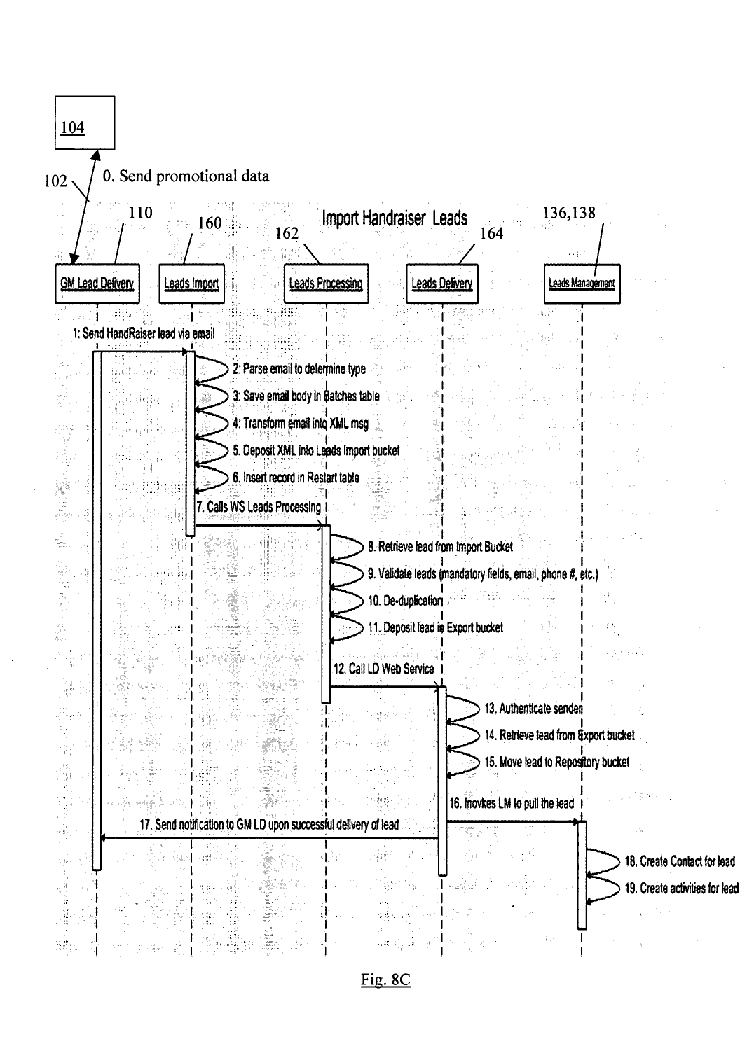

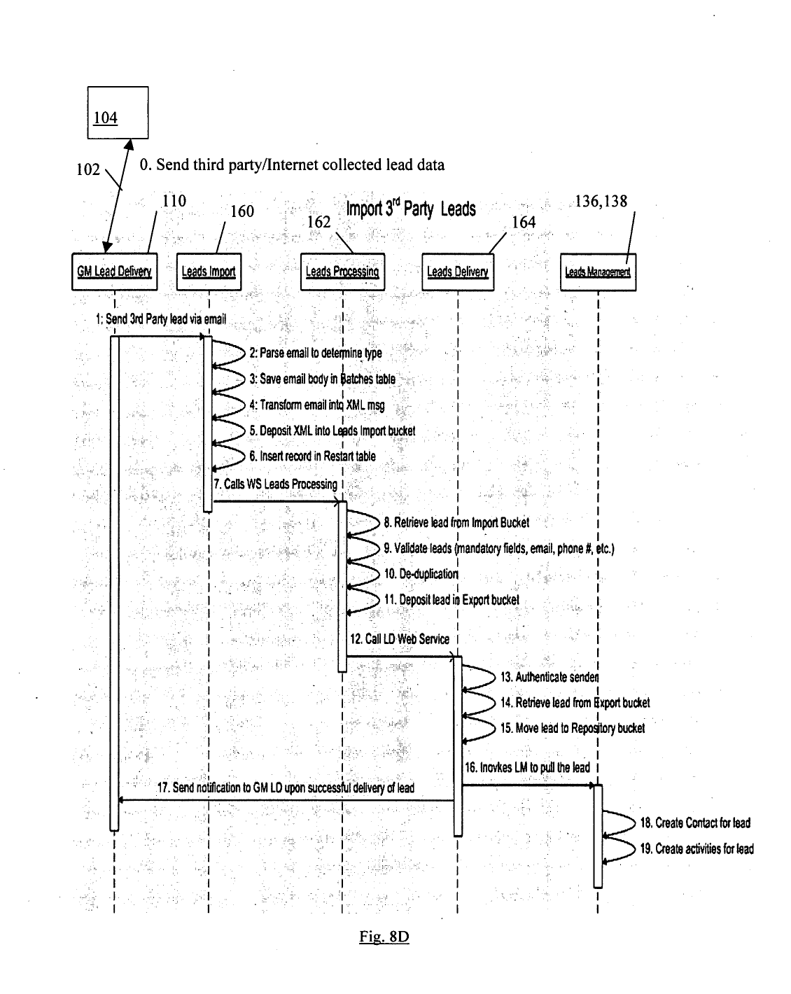

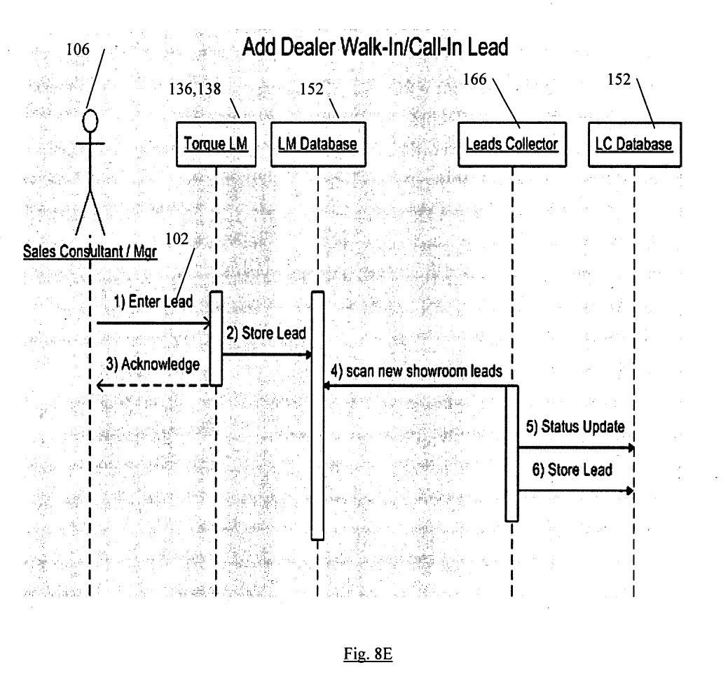

Referring to FIG. 8a, shown is an example capture of leads 102 based on leasing/finance data 122 (see FIG. 1) of the data 112. In particular, at step 1, the engine 110 is informed or otherwise is aware (e.g. due to a defined periodic download frequency of the data 122) of the lease/finance data 122, which is subsequently communicated over the network 99 to the leads delivery engine 110 at step 4. At step 5 the data 122 is communicated to the leads import module 160, subsequently processed at steps 6-9, and then communicated to the leads processing module at step 10. Steps 11-14 provide for validation of the leads 102 and then at step 15 the validated leads 102 are communicated to the leads delivery module 164. At step 19 the leads management engine 136,138 receives the leads 102 for further processing into available leads 130 via steps 21 and 22, for example. It is recognised that the leads management engine 136,138 subsequently communicates the available leads 130 to the respective dealership(s) 106 for subsequent follow-up by the users for efforts in turning the leads 130 into one or more vehicle sales, see FIG. 1.

Referring to FIG. 8b, shown is an example capture of potential leads 102 via a manifest list 126 of the data 112. In particular, at step 1, the engine 110 is informed or otherwise is aware (e.g. due to a defined periodic download frequency of the data 126) of the manifest list data 122, which is subsequently communicated over the network 99 to the leads delivery engine 110 at step 4. At step 5 the data 126 is communicated to the leads import module 160 and then communicated to the LM database 152 at step 6, for subsequent processing by the leads management engine 138 and/or at the dealership 106 for identifying potential leads 130 in the manifest lists 126.

Referring to FIG. 8c, shown is an example capture of potential leads 102 via a promotions source 104. At step 0, the engine 110 is informed or otherwise is aware (e.g. due to a defined periodic download frequency of the promotions lead data 102), which is subsequently communicated over the network 99 to the leads import module 160 at step 1. Subsequently, the lead data 102 is processed at steps 2-6, and then communicated to the leads processing module 162 at step 7. Steps 8-11 provide for validation of the leads 102 and then at step 12 the validated leads 102 are communicated to the leads delivery module 164. At step 16 the leads management engine 136,138 receives the leads 102 for further processing into available leads 130 via steps 18 and 19, for example. It is recognised that the leads management engine 136,138 subsequently communicates the available leads 130 to the respective dealership(s) 106 for subsequent follow-up by the users for efforts in turning the leads 130 into one or more vehicle sales, see FIG. 1.

Referring to FIG. 8d, shown is an example capture of potential leads 102 via a third party source or other Internet source 104. At step 0, the engine 110 is informed or otherwise is aware (e.g. due to a defined periodic download frequency of the lead data 102), which is subsequently communicated over the network 99 to the leads import module 160 at step 1. Subsequently, the lead data 102 is processed at steps 2-6, and then communicated to the leads processing module 162 at step 7. Steps 8-11 provide for validation of the leads 102 and then at step 12 the validated leads 102 are communicated to the leads delivery module 164. At step 16 the leads management engine 136,138 receives the leads 102 for further processing into available leads 130 via steps 18 and 19, for example. It is recognised that the leads management engine 136,138 subsequently communicates the available leads 130 to the respective dealership(s) 106 for subsequent follow-up by the users for efforts in turning the leads 130 into one or more vehicle sales, see FIG. 1.

Referring to FIG. 8e, dealer 106 generated leads 102 are captured via the system 108 (see FIG. 1). At step 1, the lead 102 information is captured (e.g. see FIG. 2A) and provided to the management engine 138 through the portal 132, for example. It is recognised that step 1 could be used to supply the lead 102 information directly to the lead consolidation engine 128, as desired. At step 2, the new lead 102 is stored in the lead management database 152 and at step 4 the leads collector module 166 accesses the new lead 102 information (e.g. scans the database 152 for any lead 102 data tagged as new or otherwise as dealer generated—using a dealer generated tag 205, see FIG. 2A) and stores the new lead 102 data in the LC database 152. Subsequently, the lead consolidation engine 128 (see FIG. 7) processes the lead 102 as described above.

Lead Management Engine 136, 138

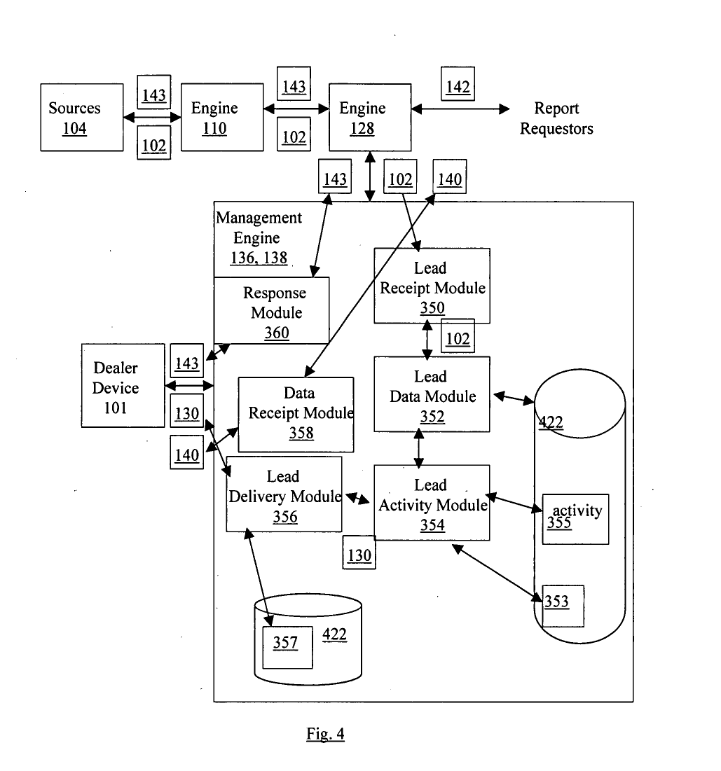

Referring to FIG. 4, shown are details of the lead management engines 136, 138, which helps to provide Dealers 106 with the ability to view, re assign and manage incoming leads 130. It is recognised that the functionality of the leads management engine, in whole or in part, can also be provided by the engine 128, as desired. The engines 136,138 have a lead receipt module 350 for receiving or otherwise requesting the incoming leads 102 from the engine 128. A lead data module 352 accepts the received leads 102 and searches the data 112 for any matches to selected data fields of the lead 102, in order to identify any related lead data that can be added to the lead 102 to result in a better qualified (e.g. greater data level of detail) of the customer and/or the vehicle history related to the information in the original lead 102, for example. The identified/supplemental data that is added to the original data of the lead 102 can be to fill in existing empty lead 102 data fields and/or to create and fill new data fields. Once transformed/supplemented, the lead data is supplied to an activity module 354 for updating the lead with required/potential activities (to be performed by the assigned user in following-up the qualified lead 130), based on the data contents of the lead and/or any activity assignment rules 355, as desired. Once completed, the now available lead 130 is passed to a lead delivery module 356 for delivery of the lead 130 to the dealer device 101 (e.g. via the dealer portal 132—see. FIG. 1). The engine 136,138 also has a data receipt module 358 for communication any feedback data 140 to the engine 128 and a response module 360 for coordinating the communication of responses 143 between the dealer 106 and the sources 104 (e.g. via the portal 132, the engine 128, and the engine 110, for example).

It is recognised that there can be a plurality of the engine 136,138 modules 350, 352, 354, 356, 358, 360, some of which are assigned to the import, processing and/or delivery of real-time leads 102 and others are assigned to the import, processing and/or delivery of batch leads 102. The use of designated modules 350, 352, 354, 356, 358, 360 based on lead 102,130 processing priority can be used to help the efficient throughput of real-time leads 102, 130 which can be useful in facilitating higher conversion rates of the real-time leads 130 based on increased response times by the dealers 106 (facilitated in part due to faster downloading of the real-time leads 130 to the engines web portal 132).

### Lead Receipt Module 350

The receipt module 350 receives or otherwise requests the incoming leads 102 from the engine 128 (e.g. the delivery module 164—see FIG. 7) and then makes the received leads 102 available to the data module 352.

### Lead Data Module 352

The lead data module 352 checks the data content of the lead 102 and then identifies what additional data can be associated therewith from the data 112 (accessed either locally or remotely via the memory 422—concerning corporate/manufacturer and/or dealer data) for subsequent transformation of the lead 102 into the available lead 130. For example, the acceptable lead data and configuration of the lead 103 can be based on rules for each lead source 104, for example for the lead source 104 of financing/leasing, the module 352 knows via the initial financing data included with the lead 102, for example, to check the lease data 122 for any additional information associated with the IDs contained in the lead 102, (e.g. customer ID, vehicle ID—VIN, dealer ID, source ID, etc.). The minimum data required in the lead 130 can include the name of the contact/customer, at least one viable contact method, and location information that allows the system 108 to identify which dealership 106 should be assigned the lead 130, as well as any information related to the vehicle (e.g. purchase, parts, maintenance, selling, refinancing, financing, etc.). The system 108 can support managing and assigning multiple leads 130 for the same consumer/customer within the same/different dealership 106.

An example of additional data 112 for further qualifying the lead 102 is the owner history data 112 for a new contact (e.g. added during the showroom visit and/or phone-in) providing all the vehicles that individual has purchased from participating dealerships 106 in the system 108. Other additional data 112 can be pre-approval status for financing (e.g. to a certain dollar amount, time, type, expiration), contact preferences (including contact restriction modes and/or times), existing lease maturity date, and other customer preferences that would potentially influence the sale of a vehicle.

Further, the module 352 can also access and add data from any of the appropriate databases 112 (e.g. 114, 116, 118, 120, 122, 124, 126) to the contents of the data fields of the lead 130. The matching of the lead 102 to the contents of the databases 112 can be done through the IDs or other of the other data in the original lead 102. Other examples of the additional/supplemental data obtained from the databases 112 include such as but not limited to: updated vehicle information; updated client contact information; and updated dealer information; etc. Accordingly, the module 352 provides for integrating the contents of the lead 130 to include all available data from the combined data bases 112, in order to provide the dealer 106 with supplemental information over that supplied with the originally submitted lead 102 (e.g. via the engine 110), in order to further assist the sales process of the dealership in connection with the lead 130.

Further, the module 352 can assign leads 130 to individual(s) within the targeted dealership 106 based on option choices by the dealer 106, for example, which can include the ability to assign by lead source and/or type, “round robin” (e.g. alternating assignment of leads 130 based on rotating selection of users), and same consumer to same salesperson. The module 352 can also have the ability to reassign leads 130 between dealerships 106 for reasons including the sale or closure of a dealership 106.

Further, the matching of the customer of the lead 102 with the data 112 contents can be done as follows:

a. Promotion Code+FirstName+LastName+(Phone#'s or Email);

b. Promotion Code+FirstName+LastName+Address1;

c. Promotion Code+Org_Name+(Phone#'s or Email); or

d. Promotion Code+Org_Name+Address1, in order to get a match for the addition of more data 112 into the data fields of the lead 102 in transformation of the lead 102 to the available lead 130 containing higher quality lead information compared to that of the original lead 102.

Further additional ways to search for a customer using a number of different filters in order to associate some of the data 112 with the current data of the lead 102 is through filter parameters (or any combination of the filter parameters) such as but not limited to: Search 1—last name and zip (both last name and zip must be entered, exact match); Search 2—Home Phone (exact match, auto adjust for area code formatting); Search 3—Work Phone (exact match, auto adjust for area code formatting); Name (return list column, First+Middle+Last name); Organization (return list column); Address (return list column); City (return list column); State (return list column); Zip (return list column)-; Home Phone (return list column); Work Phone (return list column); Program Name (return list column); Program Number (return list column); and/or Promotion Code (return list column).

Further functionality of the module 352 can be as follows:
identified in the lead 102 file sent from the engine 128 is a Leads Category Identifier which can be related to the lead Message type;
triggering an auto responder message 143 to the customer for selected lead categories if configured to do so, e.g. auto responder=Yes or No for lead category luxury;
the contact information submitted with the lead 102 is checked against the database to identify additional data 112 matches using name, address and/or phone number. If a match is not found in the dealership database, for example, the search is expanded at the enterprise level in the consolidated database 112. A match at the enterprise level will pass the enterprise_id to be included with the creation of the new contact at the dealership level. The enterprise_ID can allow for the sales history from all manufacturer stores to be shared with the dealership 106 receiving the lead 102, such as sales history of the year, make, model, and VIN of the vehicle(s) purchased. If no match is found a new contact is created in the system 108 database with the receiving Dealership's BAC code recorded against the contact record, for example;
the lead is passed through distribution & assignment rules where a sales rep numerical ID is assigned against the activity, such that there can be different sales reps assigned for different activities relating to the same lead 130, as desired;
email Notification can be sent out to the Staff/user receiving the incoming lead 130; and
the lead 130 status is set to “New” in the status data file 357.

### Activity Module 354

The module 354 provides the user dates for activities on leads 130. Every lead 130 has associated with it dates which define when action/tasks needs to occur on the lead 130, as set-up by the module 354. The module 354 allows the user to be informed of all activity that needs to be performed in relation to the lead 130. In addition to being a tool to help manage leads 130, the module 354 also is used to schedule appointments and meetings. The activities and associated dates for leads 130 can be stored in a calendar 353 for subsequent access by the assigned user via the message interface 302, further described below. The incoming leads 102 can be mapping to the respective activities based on the lead 102 category identifier. For example, an activity data structure (e.g. 353) is used to manage activity plans for each of the following lead categories: Internet; leasing; Dealer Web; Dealer Loaded; and promotional. This data structure (e.g. 353) predefined can facilitate corporate users to setup activity plans per lead source 104 and share it across all dealerships 106. For example, at the dealership 106 level, corporate defined activity plans can be automatically inherited. Each dealership 106 can additionally create additional activities for each lead 106 category in the activity plan as configured. The system 108 can provide the capability for users to view activities 280 based on status, date, type, salesperson, Dealership, and consumer, for example.

The activity module 354 configures lead follow-up activities associated with the lead 130, for example based on lead/source type as well as priority assigned to the lead 102. The module 35 can also control visibility of leads and activities based on the user's specific organization (e.g. dealership 106) structure, based on a set of predefined activity assignment rules 355. These rules 355 can be provided to the dealership by the manufacturer can be provided by the dealership independently of the manufacturer, or a combination thereof. The rules 355 can include user types for the dealerships, such as but not limited to; General Manager, Sales Manager, Sales Team, and Sales Person. All activities generated through the module 354 can be based off of the lead creation date, as per the rules 355. All activities can be a “reminder” type of activities that can be accessible in a user's calendar page (e.g. message interface 302 further described below), as per the rules 355. Further, the rules 355 can dictate that scheduled activities may not be automated to execute (i.e. emails will not automatically be sent from an activity plan).

Accordingly, the module 354 provides the system 108 with the ability to view, reassign and manage incoming leads at the dealership 106 and/or manufacturer level. Using the rules 355, the module 354 can generate standard activity plans to be set up by the manufacturer and/or dealer specific activity plans provided by each Dealership 106. For example, at the dealership level, leads can be assigned or re-assigned between sales people or sales departments. Further, for example, the activity plans of the leads 130 can be based on lead source, including one or more planned “follow up” activities with associated due dates based on lead source 104 (ex. Internet=24 hrs, promotion=72 hrs, leasing=7 days), and a “close lead” activity with no due date. The module 354 can run at the end of the Lead 102 delivery process, such as when the lead 102 has successfully been imported into the LM engine 136, 138.

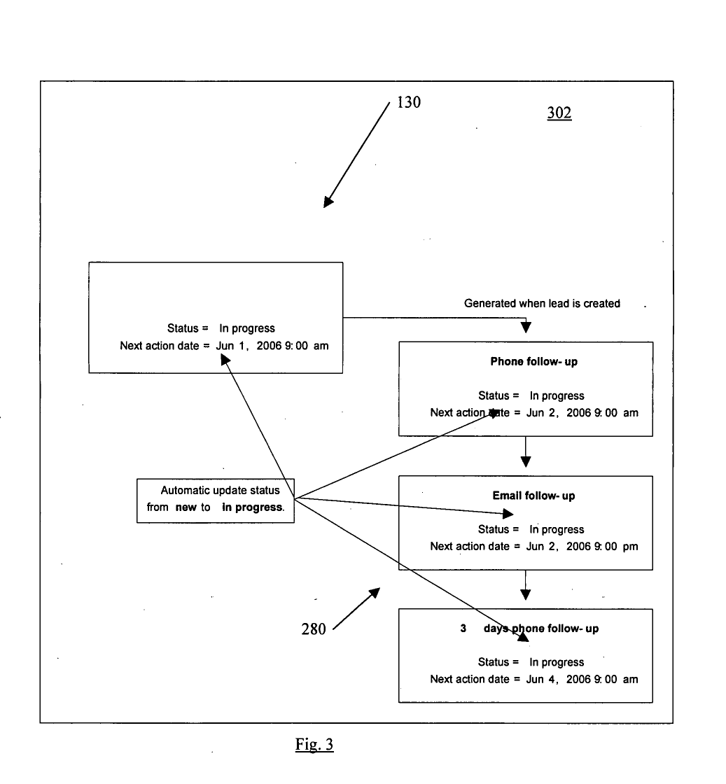

Activity examples can be such as but not limited to send message (telephone/email) with what content by what date. It is recognised that more than one activity can be associated with each lead 130. Further, each activity can be defined to include parameters such as but not limited to: activity name; activity due date and time; activity instructions (e.g. such as a pop-up window that assists the user in constructing the appropriate message or other task to completion). It is recognised that as each activity is scheduled and completed (or not) by the scheduled due date and timing (and/or activity content—phone call versus email), a corresponding activity entry is recorded by the engine 136, 138 (e.g. by the modules 358, 360 (see FIG. 4) in the status file 357, which is made available or otherwise accessed by the report engine 129 via the collection of the status file 357 contents as feedback data 140. Further, all Activities can be accessed through the calendar portion of the messaging interface 302. Activities that are derived from an Activity Plan can have a different appearance on the screen than an activity based on a standard lead, including different looks/formats for displayed activities based on; urgency (how close to the activity deadline the current time is), lead category/type (some leads may take precedence over others), and other factors. Activities can be designed to act as “reminders” and to guide the user back to the lead 103 detail shown in the message interface 302 in order to assist in the execution of the planned Activities. Referring to FIG. 3, shown is an example activity plan for a respective lead 130, as viewed on the message interface 302 (see FIG. 9). It is noted that there can be more than one activity 280 scheduled for each lead 130.

### Leads Delivered Module 356

The leads delivery module 356 delivers the available leads 130 (e.g. as a single or group of leads) to the dealer's 106 network/e-mail address. For example, the module 356 can send a message to a dealer's pager when a new lead is received by the message interface 302 (see FIG. 9), further described below (e.g. dealers can be able to select which lead source 104 they want to be notified about upon arrival of the lead 130 at the message interface 302). The format of the available leads 130 can be delivered in a number of different formats, as expected by the dealership 106, e.g. ADF, STAR, fixed file, email and delimited formats.

The module 356, once receiving confirmation of the delivery of the leads 130 to the dealer 106 (e.g. as proxied by the messaging interface 302 of the dealer portal 132—see FIG. 1), also updates in memory 422 (e.g. of the system 108) the delivered status in a status file 357 of the leads 130. It is recognised that the modules 358 and 360 also have access to store status data in the status file 357. The status file 357 is available for use in formulating the feedback data 140 by the data receipt module 358, as required.

### Data Receipt Module 358

The data receipt module 358 provides for communication of any feedback data 140 between the dealers 106 and the engine 136, 138, as well as between the engine 136, 138 and the engine 128.

### Response Module 360

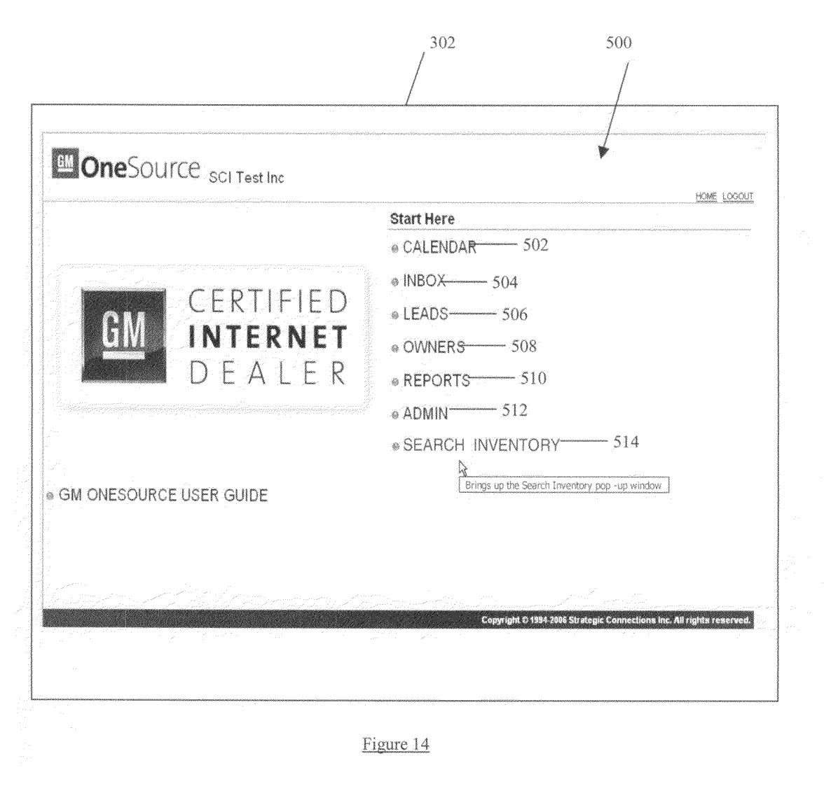

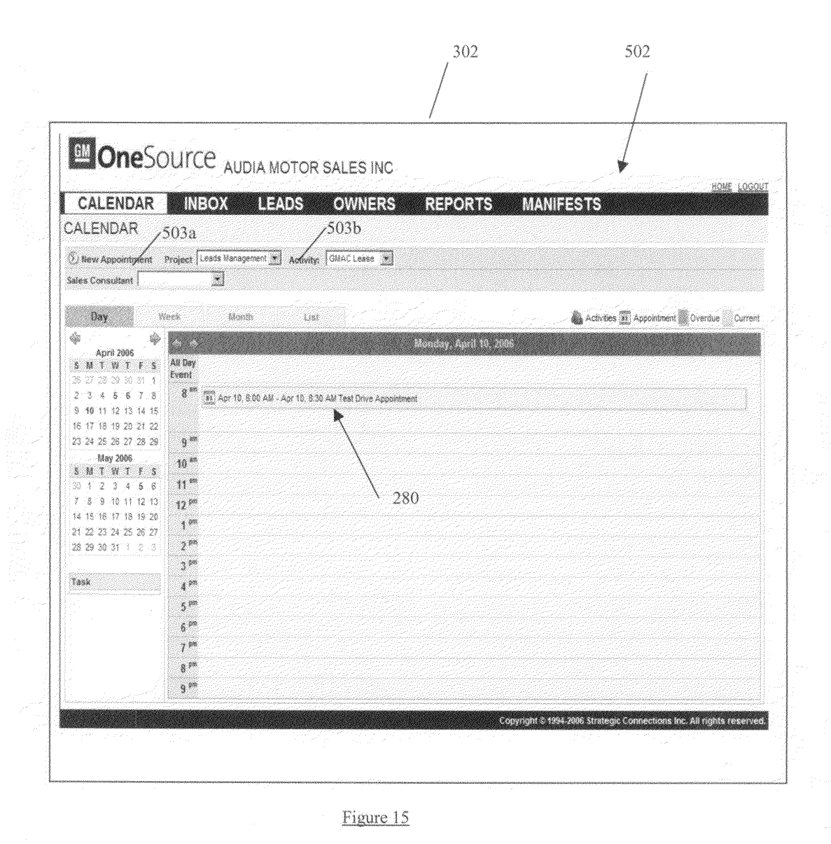

The response module 360 provides for facilitating generation and/or communication of any response data 143 between the dealers 106 and the engine 136, 138, for subsequent receipt by the customer originating the lead 102 (e.g. the source 104), further described below. For example, a Send Email/message feature (of the Inbox view 504—see FIG. 14) provides a library 312 of predefined templates 314 from which the user may select the appropriate type. After selecting am email template 314, the template 314 is populated with contact and lead 130 information such as vehicle of interest, as well as any data gathered by the user in preparation for the response message 143. The template 314 may be one of the packaged templates 314 of the system 108 or dealer 106 defined. Accordingly, the module 360 can facilitate access to the library 312 by the user of the tools 300 (see FIG. 9).

### Dealers 106

The dealer 106 can be further subdivided into Dealer Consultant and a Dealer Sales Manager. The Dealer Consultant is the dealer user sales person assigned to work the dealer showroom floor and assist customers and prospects in the selection of a vehicle that suits their lifestyle and transportation requirements, including following up on the leads 130 accessed via the system 108. The Dealer Sales Manager is the first level management role within a dealership managing a sales team of sales consultants in the managing of business opportunities and prospects in an efforts to maximize the close ratio for new vehicle sales, including following up on the leads 130 accessed via the system 108. The Dealer Sales Manager can also be the personnel within the dealership 106 responsible for a sales team or multiple sales teams and the setting up of and monitoring of individual Activity Plans for any given number of leads 130.

### Lead Response Tools 300

The following example of the lead response tools 300 is given for the case of assignment of the leads 130 to the dealership by the leads management engine 138, by example only. It is understood that the tools 300 can be implemented by the dealership 106 on one or more devices 101, as described above. It is recognized that the tools 300 (or portion thereof) can be located locally on the dealership devices 101 and/or can be hosted on the system 108 remotely from the dealership 106 and accessed over the network 99 (e.g. through the portal 132 as a web service).

Referring to FIG. 9, the lead response tools 300 of the dealership 106 are available to a selected user of the dealership 106, such as but not limited to: the dealership's sales consultants, the sales manager, the dealership owner, the dealership administrator, or whoever has access to the lead response tools 300, for example. The user uses the lead response tools 300 to process any leads 130 that have been assigned to the respective user by the leads management engine 138, in order to the respective user to interact with the customer associated with the lead 130 that is interested in purchasing one or more vehicles. Output of the response tools 300 can be monitored by a reporting module 301 for communicating the feedback information 140 back the system 108, e.g. via the leads management engine 138, for subsequent use in generation of the reports 142 (see FIG. 1).

The response tools 300 have a message interface 302 for access by the user of the dealership 106, in order to gain access to, select, and interact with all leads 130 assigned to the respective user of the dealership 106. The leads 130 are in the form of network 99 messages, as further described above. The tools 300 also have a vehicle search module 304 configured to allow the user (e.g. Sales Consultant) to perform a search of inventory for a specific vehicle from the memory 422 of the dealership 106 (and/or from the memory of the system 108 as desired), based on the requested vehicle information 200 (see FIG. 2b) such as model, color and/or option sets, during the discovery process with a customer in processing of the selected lead 130. Accordingly, the user has the ability to search vehicle inventory via the search module 304. For example, the current dealership BAC code can included in the search parameters, which can determine if the user can search more than their own dealership 106 for the search. Further, the search may be done on make/model or VIN number, as desired. Therefore, the search module 304 facilitates incoming leads 130 to be matched against VIN Build data available originally from the data 112 imported into the system 108. This can allow dealers 106 to respond to leads 130 with in-stock inventory suggestions (via response messages 143) of vehicles they currently have in stock (or the vehicles that other dealers 106 have in stock) with certainty regarding the correctness of the configuration of and the options on the vehicle.

Referring again to FIG. 9, the tools 300 also have a sticker data module 306 for accessing window sticker data 307 (e.g. US brands window sticker data) once a specific vehicle(s) has/have been identified by the user during the discovery phase of the lead 130 follow-up with the customer. The data 307 can be included in the lead response message 143 generated by the user and communicated back to the customer over the network 99 (e.g. via the portal 132). For example, the lead response message 143 can be generated by a response module 310 using a selected message template 314 (from a list of predefined templates 312) and include a quotation data suitable for population of selected/defined data fields of the templates 312 for that specific vehicle prepared for the customer that is intended in reply to the original vehicle information 200 (see FIG. 2a). For example, the quotation can include detailed specifications, picture, and/or windows sticker data 307 for the vehicle (s) selected for quotation by the user. The lead response message 143 is forwarded to the lead delivery engine 110 for subsequent delivery back to the associated customer, for example.

### Templates 312

Referring again to FIG. 9, the responses 143 by the dealers 106 for working the received leads 130 can be configured through the use of message templates 314 (e.g. email templates), which are a set of predefined templates that a corporate, dealer or sales consultant can use in his or her response communications 143 with active prospects (e.g. for the purpose of consumer contact and/or sales follow-up) for use in response to specific customer email/message communications. The sales consultant can provide value added details to the consumer based on his/her desire for a particular make, model and feature set for the vehicle they are interested in, through use of the templates 314. The templates 314 can facilitate the functionality to send pre-defined and preformatted e-mails/messages to leads 130 tracked in the system 108, populated with the response data collected by the user (e.g. through the messaging interface 302). The templates 314 can be created by corporate marketing as part of a program or campaign and sent to the dealers 106 for their use. Dealers 106 may copy, delete or create their own version of the templates 314. Sales Consultants can select a template 314 from the library 312 and use it such that they cannot change or create their own templates 314 (other than input valid data in the provided template fields in creation of the response message 143), and/or may also be given the option of creating/modifying selected templates 314 for their own use, based on the configuration of the leads management engine 136, 138.

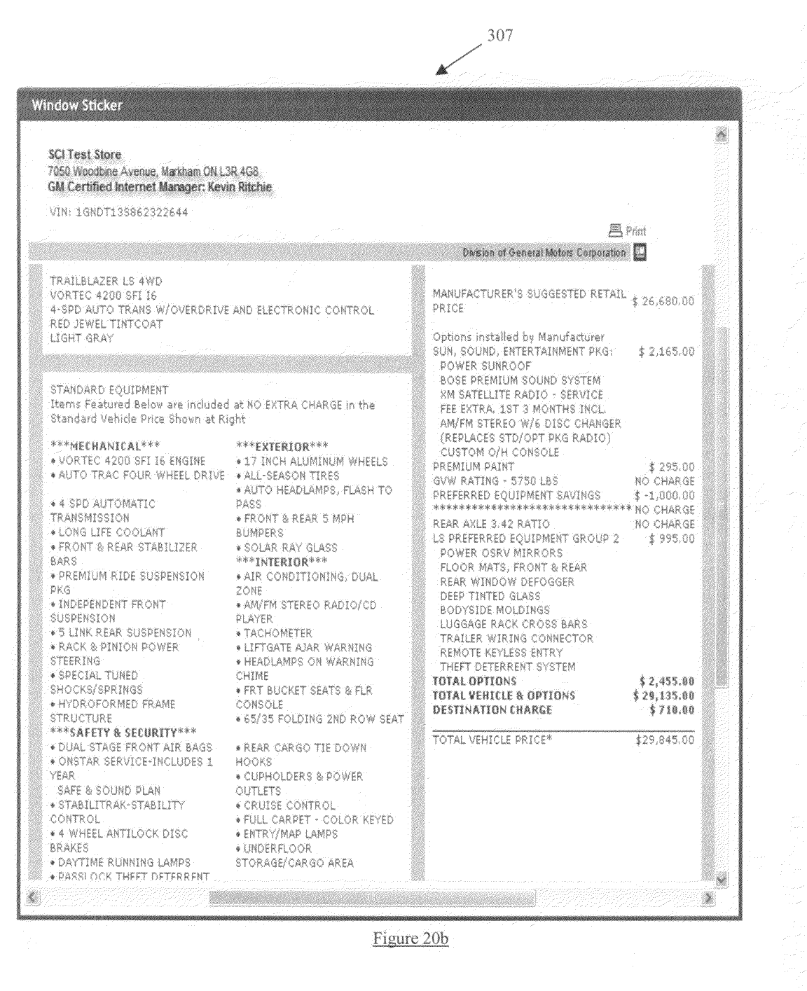

It is recognised that the system 108 can automatically update the status of the lead 130 (e.g. from new to “in progress”) based on the responses 143 delivered to the customer. The responses 143 can be tagged or otherwise identified with a template ID, which is recognised by the system 108 in order to identify the stage of the lead 130 processing by the user (e.g. initial response, sent quote, sent revised quote, sent financing details, ended the lead 130 on good terms, etc.). Accordingly, the system 108 can use assigned template IDs for tracking the content of the messages 143 and ultimately the progress of the lead 130 processing by the user. It is also recognised that the templates 314 can include a number of sub templates, each having their own template ID (e.g. template name, template type, lead 130 processing stage that the template applies to, lead category, etc.). Accordingly, any particular response message 143 can be composed of a number of templates with their corresponding template IDs. For example, any of the features of the sticker data 307 (see FIGS. 20a, b) (e.g. car image, total options, total vehicle & options, destination charge, total vehicle price, safety & security features, exterior & convenience features, spacious interior features, and power train & chassis features) can be provided via specific templates and associated template IDs. In this manner, the system 108 can also be used to track the content of the messages 143, to help facilitate monitoring of quality of service as well as sales techniques of the dealerships 106 (e.g. some users always quote/suggest all vehicle options while other users only quote limited options, or certain response information may not be always included in the response messages 143 (e.g. all financing options).

The message templates 314 can be stored in the library 312 of templates within the system 108, and thus provided to the dealership via the portal 132 (see FIG. 1), and/or be stored locally for the dealer device 101. A user may select any template 314 from within the library 312 and populate the template with existing data from his/her lead information gathered through use of the tools 300 (see FIG. 9). The templates 314 can provide for allowing the Dealers 106 to send emails/messages 143 that include attachments, dealer logos/slogans, and/or embedded text/pictures related to the desired vehicle(s).

The templates 314 may be modified to suite the dealership's 106 unique style and presentation format. Alternatively, only manufacturer administration and/or dealership management may create, change, copy and delete a template 314 from within the library 312. Further, for example the library 312 can reside within the system 108 and may not require any local disk space of the dealership devices 101 for storage of the template 314 data.

The templates 314 facilitate the implementation of consistent user behaviour and/or a consistent “look and feel” for a specific program or marketing campaign. The templates 314 help to provide a consistent “look and feel” of all correspondence associated with a specific program or campaign, for example regardless of the originating dealership when responding to a prospect/customer associated with the program. The Dealership users my also be granted administration rights to create unique e-mail templates that will conform to the unique style of the individual dealership 106, as desired. For example, a template management process can facilitate adding, changing, deleting and creating of both text and unique graphics within the body of the email/messages 143. All text and graphics for the template 314 can be stored within the system 108 applications, thus potentially needing little to no additional storage facility at the dealership 106, for example.

Further, the templates 314 can be used to assist the user in formulating the response messages 143, such as but not limited to: display a user friendly message/warning as well as an “in editor mode” indicator when a template field does not have any information to merge; restrict the user from sending the message 143 or provide a warning to the user if merge fields are missing when they click send; allow the user to display blanks when merge field data is missing; and display error tags within body of email in red when the message content is contrary to the field definitions of the template 314 (e.g. image rather than text, numbers rather than letters, etc.).

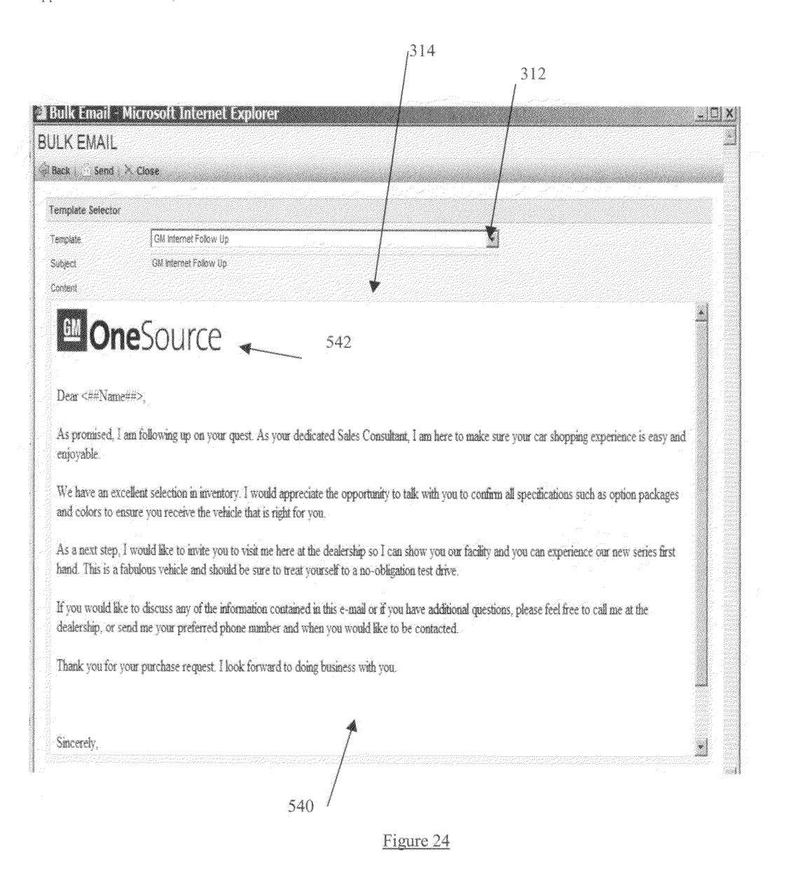

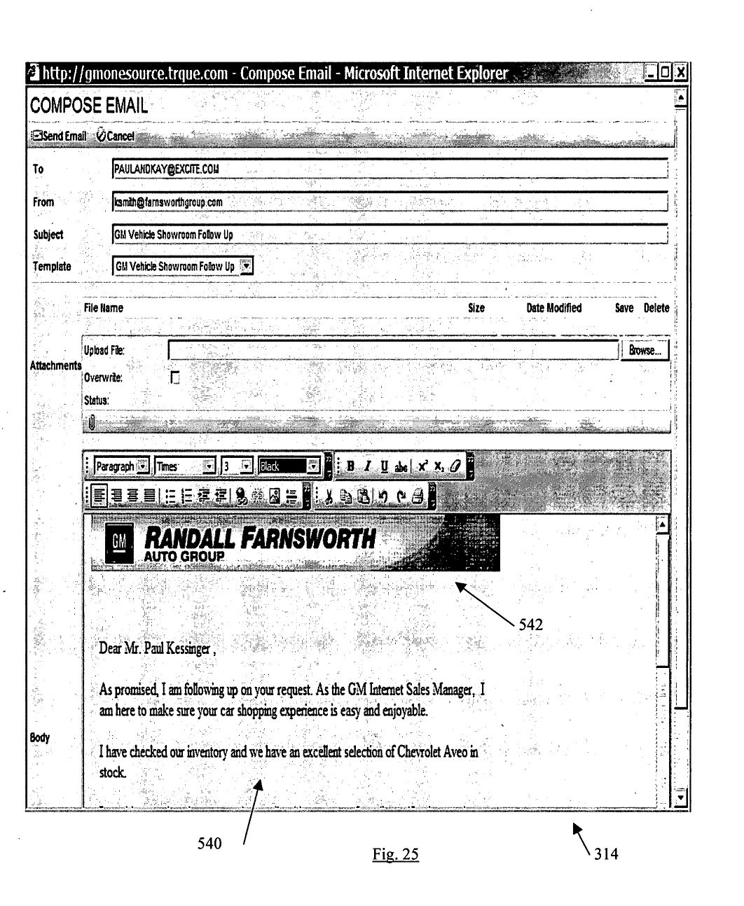

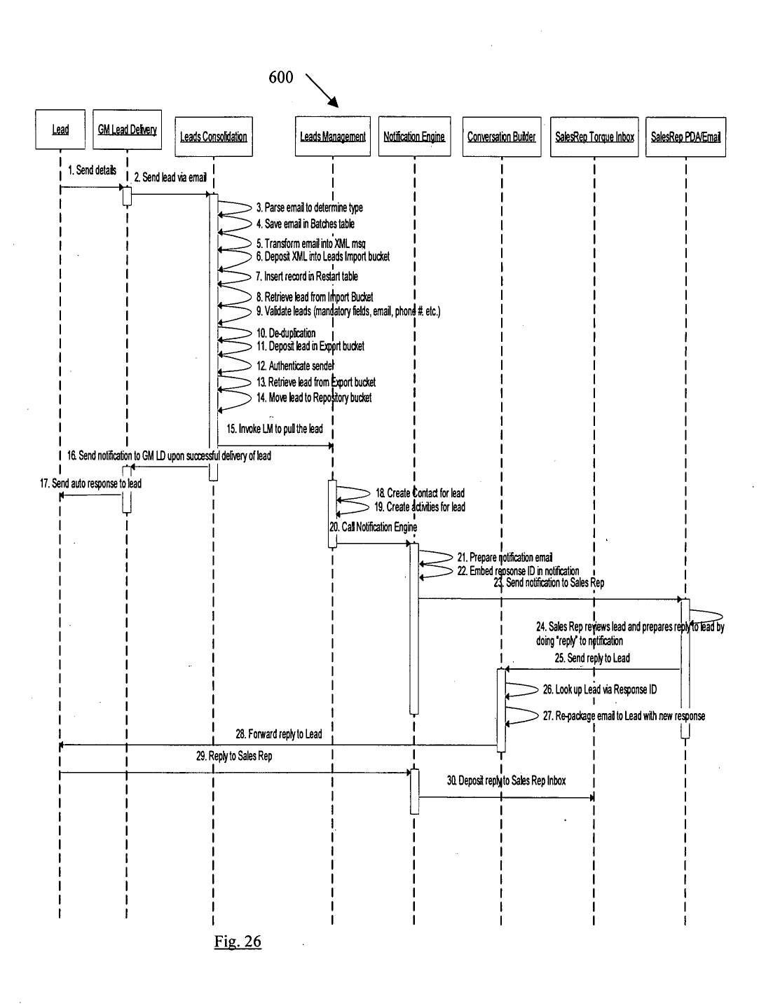

Referring to FIGS. 23, 24, 25, are example templates 314, including content portions (e.g. sub-templates 314) for text 540 and images 542, for example. The template 314 fields can be used to position. the location of the content on the page, the size of the content on the page, the format (e.g. font style, colour) of the content, any background formatting, the amount and/or type of content, etc, as desired.

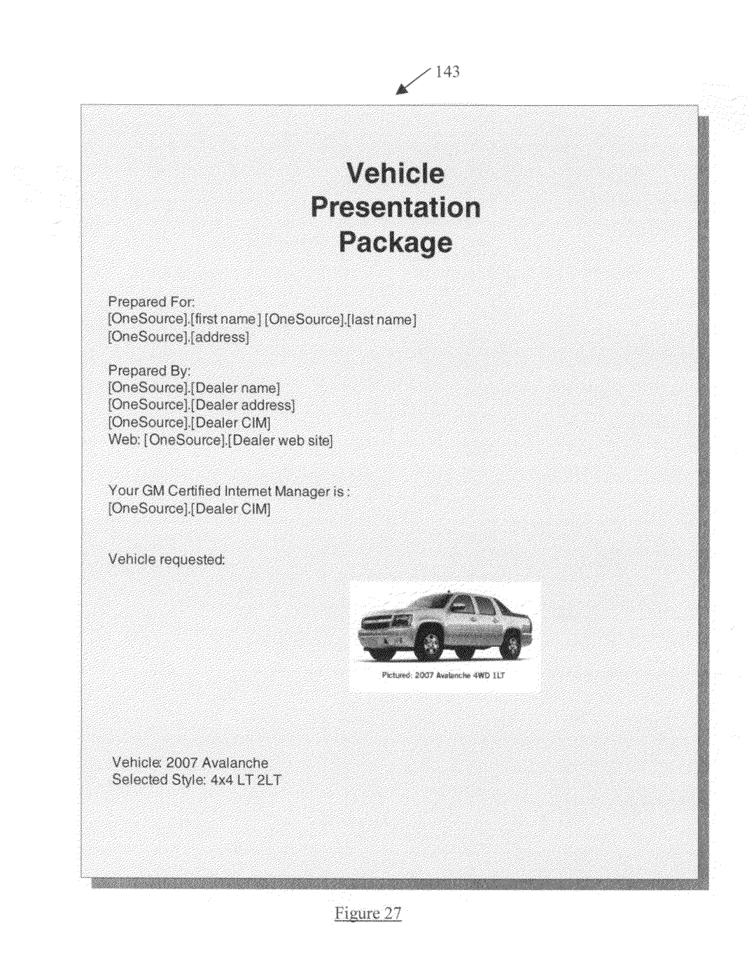

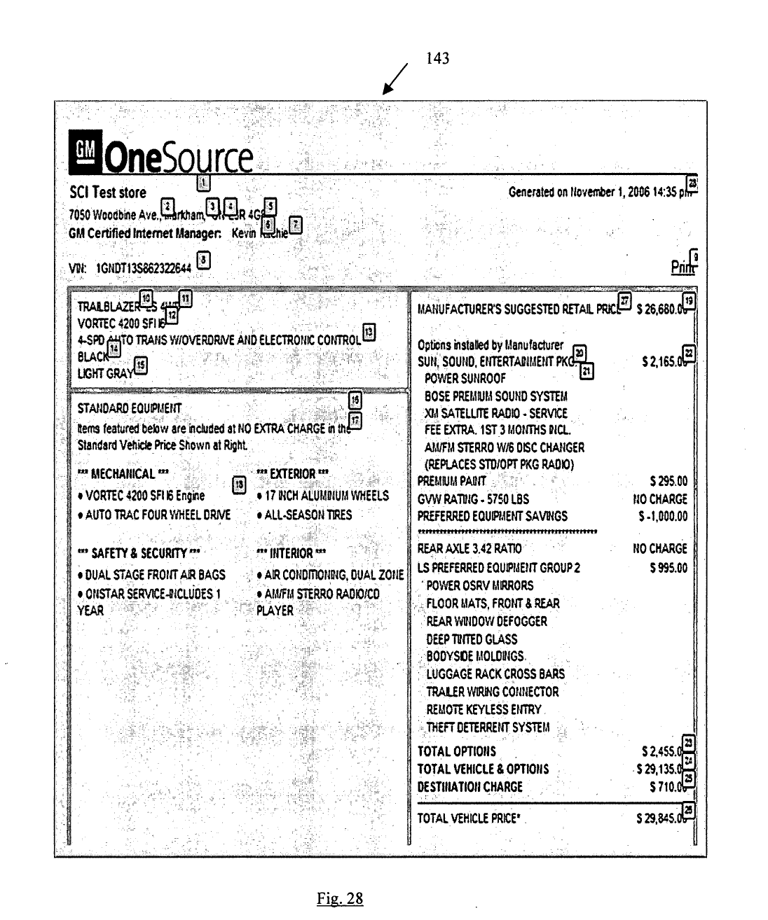

Referring to FIGS. 27 and 28, shown are example message 143 content with example selected sub template 314 items (referenced by numbers 1-28). The following is a description of the items 1-28, namely

1 Dealership name being the Users' dealership name.

2 Dealer address—Street being the Street portion from the dealership address.

3 Dealer address—City being the City portion from the dealership address.

4 Dealer address—State being the State portion from the dealership address.

5 Dealer address—Zip being the Zip code portion from the dealership address.

6 Internet Manager first name being the First name for the internet manager.

7 Internet Manager last name being the Last name for the internet manager.

8 VIN being the VIN of the vehicle related to the lead 130.

9 Print button being the Trigger the web browsers print function.

10 Model being the Model number.

11 Trim being the Trim code.

12 Engine description being the Engine description of the vehicle.

13 Transmission description being the Transmission description of the vehicle.

14 Exterior color being the Exterior color description.

15 Interior color being the Interior color description.

16 Standard equipment label being a text label to indicate standard equipment.

17 Standard equipment detail label being a label text to explain the standard equipment.

18 Standard equipment bullet list being a bullet list of standard equipments.

19 MSRP being a MSRP of the vehicle.

20 Option family code denoting a package of options.

21 Option item being an individual option item in an option family.

22 Option price being pricing information of an option.

23 Total options price being a sum of the pricing for all the equipped options of a vehicle.

24 Total vehicle price being a sum of the pricing for all the equipped options plus MSRP of a vehicle.

25 Destination charge being a destination charge of a vehicle.

26 Total vehicle price being a grand total price of a vehicle.

27 MSRP label being a label text to indicate MSRP.

28 Timestamp being a timestamp that record when the window sticker created.

### Message Interface 302

Referring to FIG. 14, shown is a summary page 500 of the messaging interface 302, which is available upon sign-on (e.g. log-in) of the user on the dealer portal 132 (see FIG. 1), for example. The summary page 500 can include a number of information categories that can be used to work an assigned lead 130, categories such as but not limited to: calendar 502; message inbox 504; leads 506; owner information 508; reports generation/access 510; administration functions 512; and search inventory 514. Accordingly, the services of the system 108 can be made available to Dealers 106 and manufacturer Operations via the portal 132.

It is recognised that the visible content of the messaging interface 302 can be based on user privileges of the signed on user, as desired (e.g. a sales associate may not even see the categories of reports 510 and administration 512). For example, managers can have visibility to their subordinate's leads and activities, while visibility to any leads or activities that are not assigned to the user or the user's subordinates are inhibited.

### Calender 502

Referring to FIG. 15, shown is an example display of the calendar function 502 on the messaging interface 302 including a list of activities 280 related to follow-up processing of the assigned leads 130 to the respective user. The calendar 502 can provide users with an alternative way of identifying and tracking their leads activities 280. For example, the calendar 502 can be organized into a day, week, month and list view providing users the ability to schedule tasks and appointments (e.g. activities). It is recognised that managers can have the ability to view team and individual staff's calendars 502 to gain greater visibility into the leads activities 280 in the store(s) and promote one-on-one coaching opportunities. All active leads 130 and appointments 2800 may be accessed from the calendar 502, where activities 280 that become overdue can be visually distinguished from other activities (e.g. change color from green (Current) to red (Overdue)) or otherwise automatically generation overdue calendar reminder messages. Selecting a New Appointment button 503a in the top left section of the calendar view 502 can set appointments and other activities 280. It is also recognised that activities 280 may be filtered in any view (Day, Week, Month and List) through the Project and Activity drop down controls 503b.

Accordingly, the calendar 502 can be used to manage all leads activities 280 that have a due date and time, which determines when they appear against the user's calendar 502. Further, selecting an activity 280 in the calendar 502 can produce a respective leads follow-up form or otherwise display the related lead 130 on the message interface 302. Other example calendar functionality can include: any updates to the next call date and time on the lead form is adjusted in the calendar view 502; if a lead 130 is updated with a closed status e.g. #Lost, # New Car Sold, the lead 130 is be dropped from the calendar view 502; and all updates to the leads 130 including all contact history is saved as well as reflected in the calendar view 502, as desired.

### Inbox 504

The Web mail/message view (e.g. Inbox 504, or also Sent Box, Drafts, etc.) of the messaging interface 302 allows the sales consultant to send, receive, and manage emails/messages associated with selected leads 130. The Inbox 504 can be viewed as the primary view used by system 108 users to identify incoming emails/messages. The Inbox provides a consolidated view of all email/message activity related to specific contacts/leads 130 a user is permitted to see. The Inbox 504 can also be referred to as a message center. The contents of the inbox 504 are each associated with their respective lead 130, which can be viewed in connection with any message on the messaging interface 302 (e.g. the user can opt to review the lead 130, as well as any associated messages 143, before further responding to the customer). Accordingly, each of the messages in the Inbox 504 can be assigned the unique identifier of the lead (e.g. lead ID, batch ID, source ID, customer ID, sales associate ID, dealer ID), or any combination thereof, with the intent to make identification and review of messages related to particular leads 130 straightforward to the user, via the messaging interface 302.

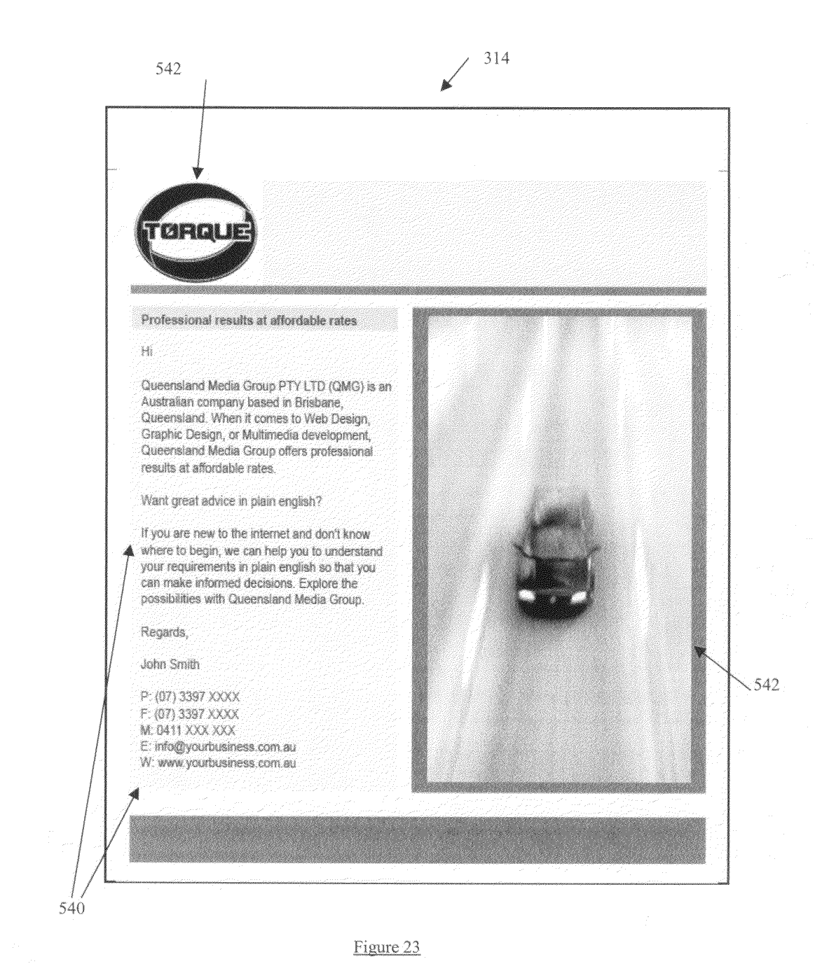

This Inbox 504 view can be initiated from the home/summary view 500 (see FIG. 14). Tracking email/messages 143 for a particular lead 120 and sending email/messages 143 to the customer related to that lead could also be done from the lead view 506. The Web mail (e.g. Inbox 504) feature provides users the functionality to compose, receive, reply, and view emails/messages 143 (both sent and received as well as the original lead 130). For example, emails can be sent to leads 130 and replies from the customer can be associated with the lead 130 on return via the unique identifier of the lead. This allows the sales person to manage the leads 130 needs and respond to the consumers' subsequent requests. Other features of the Inbox 504 view can include. the ability to create folders, move messages, view new (unread) messages, sort, search, archive, spell check, and save draft messages. Also provided can be the ability to maintain email history when replying to a respective lead 130, as well as ‘reply to all’, and forward. It is recognised that a notification message can be provided to the user by the Inbox view 504, upon receipt of a lead 130 or if a customer response is received. Referring to FIG. 22, shown is an example Inbox 504 view on the messaging interface 302.

Further, the Inbox 504 view can facilitate Dealers 106 to send “Bulk” emails/messages 143, to have the capability to store consumer and Dealer 106 email text/attachments/images with the lead 130 for a specified period of time (e.g. at least 12 months). The system 108 can also store lead 130 histories for each contact and with associated email/message text or notes, as related through the lead ID used to tag both the lead 130 and the related emails/messages 143 in the system 108.

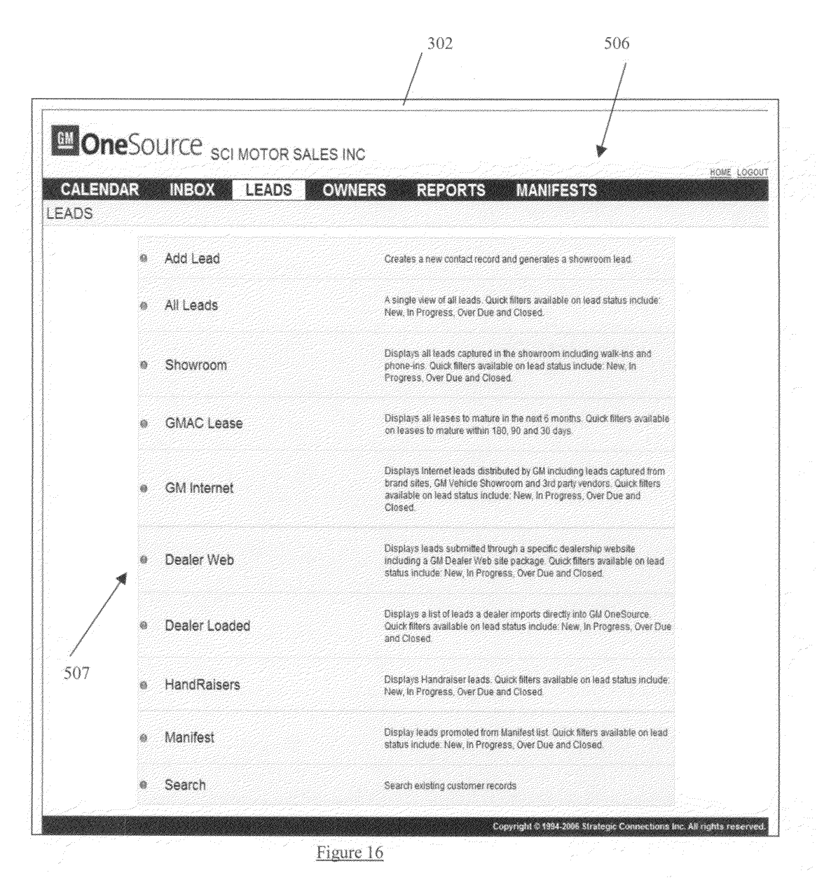

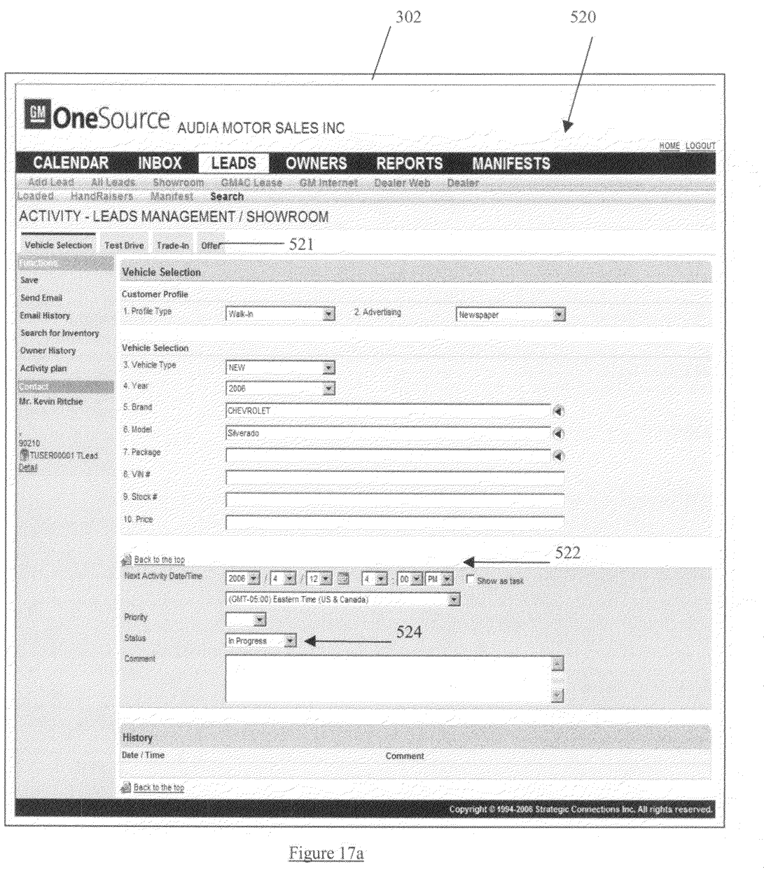

Further, Bull: email/messages may be set-up from all leads categories 507 views (see FIG. 16) including such as but not limited to; Internet, leasing, Dealer Web, Dealer Loaded, Handraisers/promotions, Manifest, and dealer showroom. In the bulk email/message setting, the user defines the list to upload to a bulk email engine by choosing one of the filters for the view i.e. New, In Progress, Over Due, Closed, All (exception being leasing). Leasing views may be filtered by the following: 30 days, 90 days, 180 days, or any other time period. Further, by selecting the Bulk Email button, the list is uploaded where additional filters may be applied against the final distribution list. It is recognised that only contacts with an email/network address can be uploaded to the bulk email list.

Additional filters can made available to refine the email distribution list including parameters such as but not limited to; Lead Source, Lead Type, Sales Consultant, Creation Date, Next Action Date, Vehicle Type, Brand, and Model. The additional filters are populated with the information available for each lead category view. The final list is attached to an email template(s) 314 selected from the library 312 and processed through the email processes of the Inbox 504 and related message generation modules (e.g. module 360—see FIG. 4).

### Leads 506

Referring to FIG. 16, shown is an example lead view 506 on the message interface 302, showing a number of lead types/categories 507 such as but not limited to: add lead (dealer input lead information that allows the user to manually add a new opportunity that either phone or walked into the dealership 106); all leads; showroom also referred to as dealer initiated leads; leasing leads; Internet leads from the manufacturer; Internet leads from the dealer 106; leads imported from the dealer 106 to the system 108; handraiser also known as promotional leads; manifest leads; and a search function (e.g. facilitated via the search module 304 of the tools 300—see FIG. 9) that provides a quick means of identifying contacts based on name, company and phone (home, office, cell), for example. The leads 130 can be organized into the distinct categories 507 based on their source 104, for example. Accordingly, the user can see the lead 130 categories 507 that are assigned to them as well as any leads 130 that are resident in the categories.

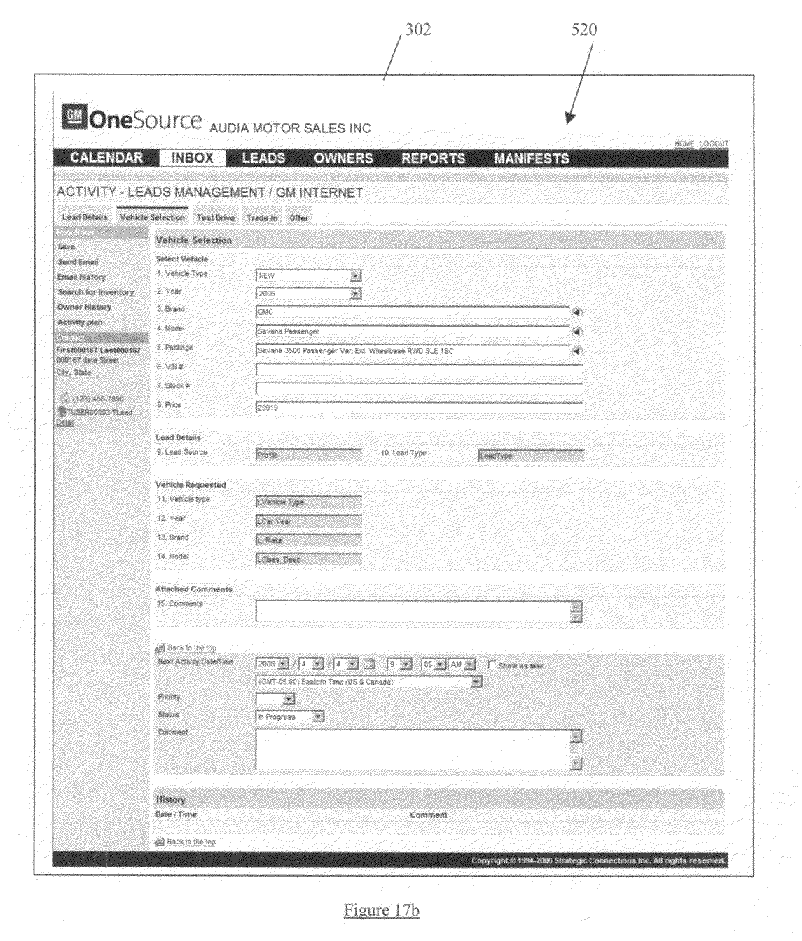

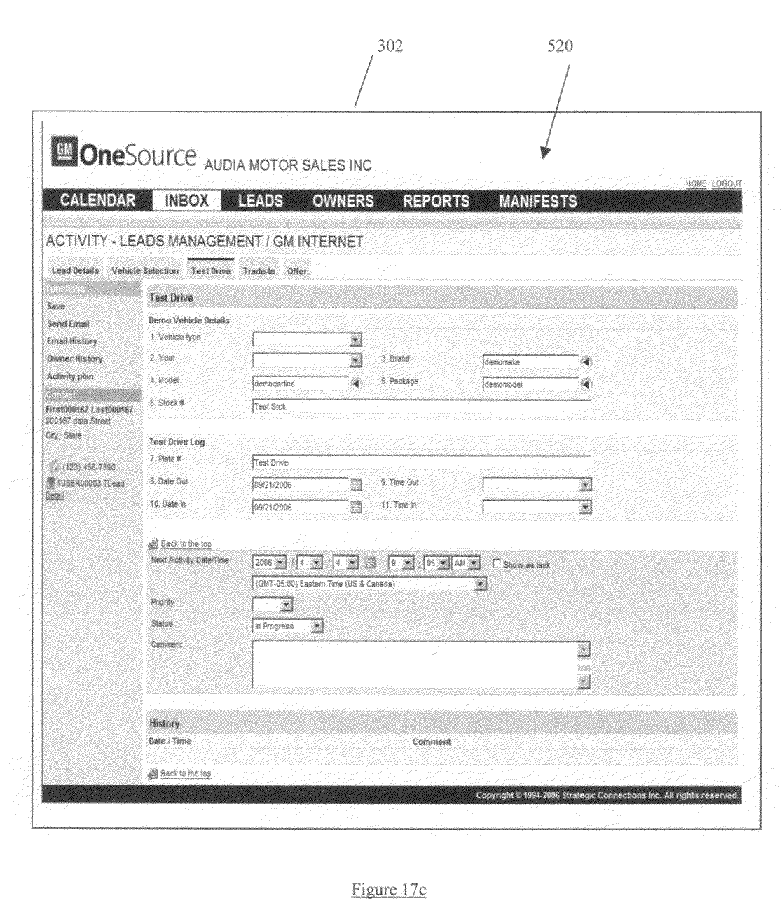

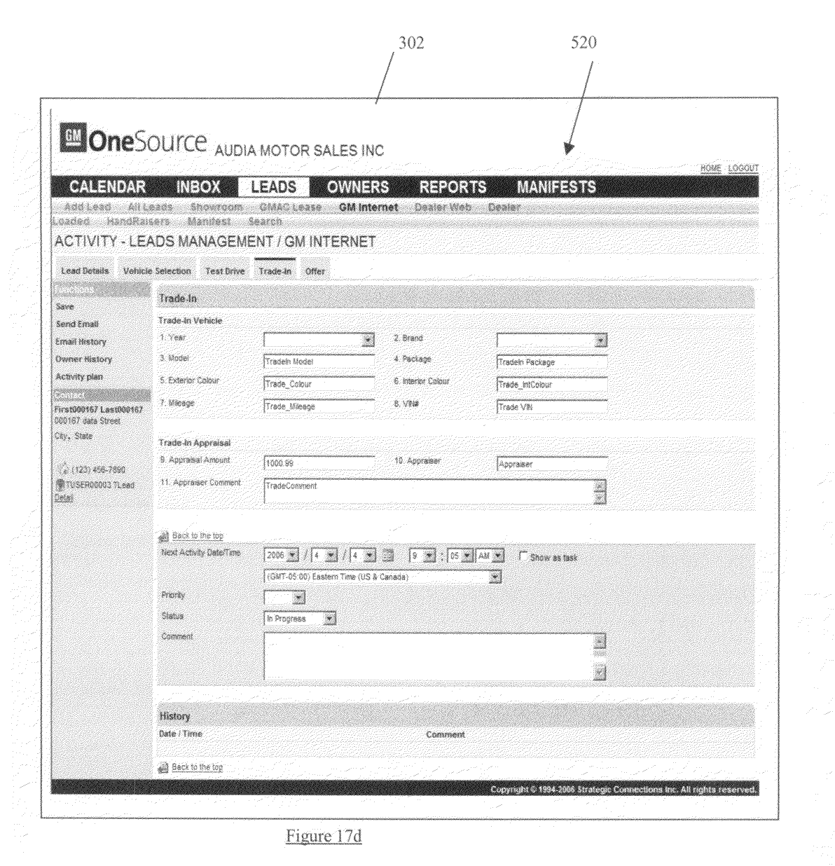

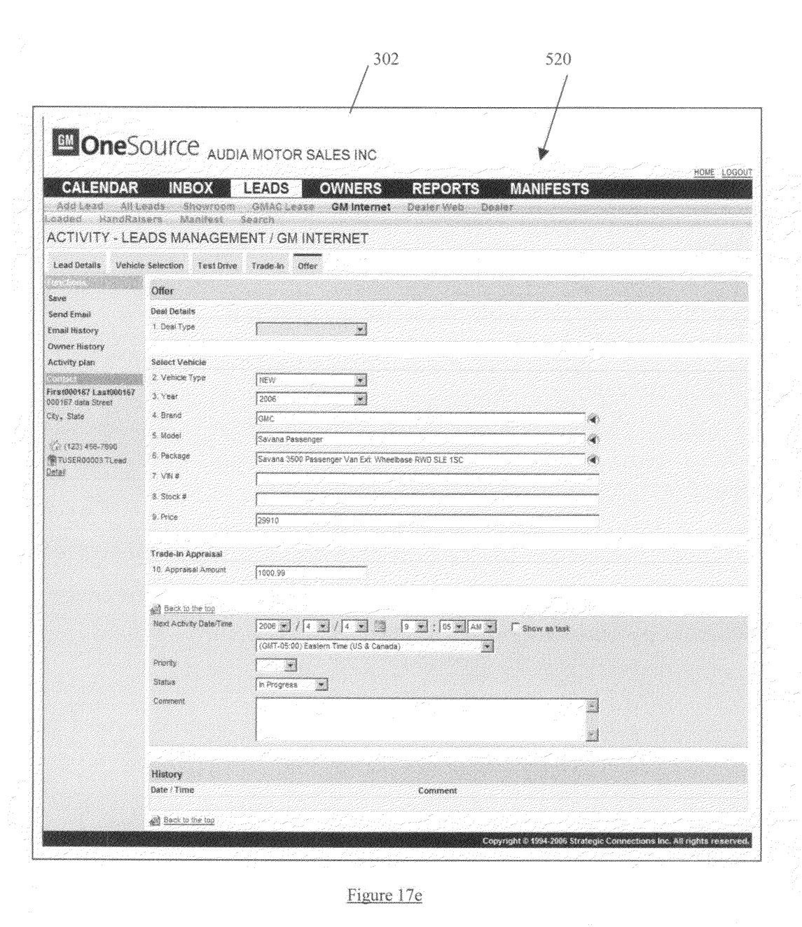

Referring to FIG. 17a, shown is an example lead form set 520. It is noted that the leads form 520 contains selectable views for Leads Details 521 for facilitating the collecting and tracking of Vehicle Selection, Test Drive, Appraisal, and Offer stages of the sale associated with the lead 130. Further, the user can define a next action/activity date by updating the Next Call Date Time 522. Further, the lead 130 status 524 may be manually adjusted and identified, as configured. It is recognised that due to the differences in the data collected at each lead source, the lead details 521 content can vary for each lead category 507 (see FIG. 16). FIGS. 17b, 17c, 17d, 17e show other selectable leads details 521, as displayable by the lead form set 520. Accordingly, it is recognised that the leads details 521 of the form set 520 can be used in tracking and managing of the lead status by the user. For example, selection of any of the displayed data in the details 521 can link the user with any messages 143, 130 that the selected data is referenced in (e.g. the user can quickly find the activities 280 and associated messages 143 that are related to offer details data in the lead form set 520), so that the user can maintain lead follow-up context for leads activity that occurs over an extended period of time. Further, for example, the user upon selecting any of the vehicle selection data in the displayed lead form set 520, can be linked or otherwise directed to the messages 143 that contained the vehicle quotations and other vehicle information, thereby allowing the user to quickly adjust the earlier generated message 143 contents for use as a revised message 143 for sending to the customer (e.g. a revised quote based on the addition/subtraction of vehicle options).

The lead form set 520 can provides the following functionality; the views for each tab help organize and collect data for each step in the sales process; and within each tab are defined functions to view Owner History, Send an Email and Email history for the specific contact name attached to the lead.

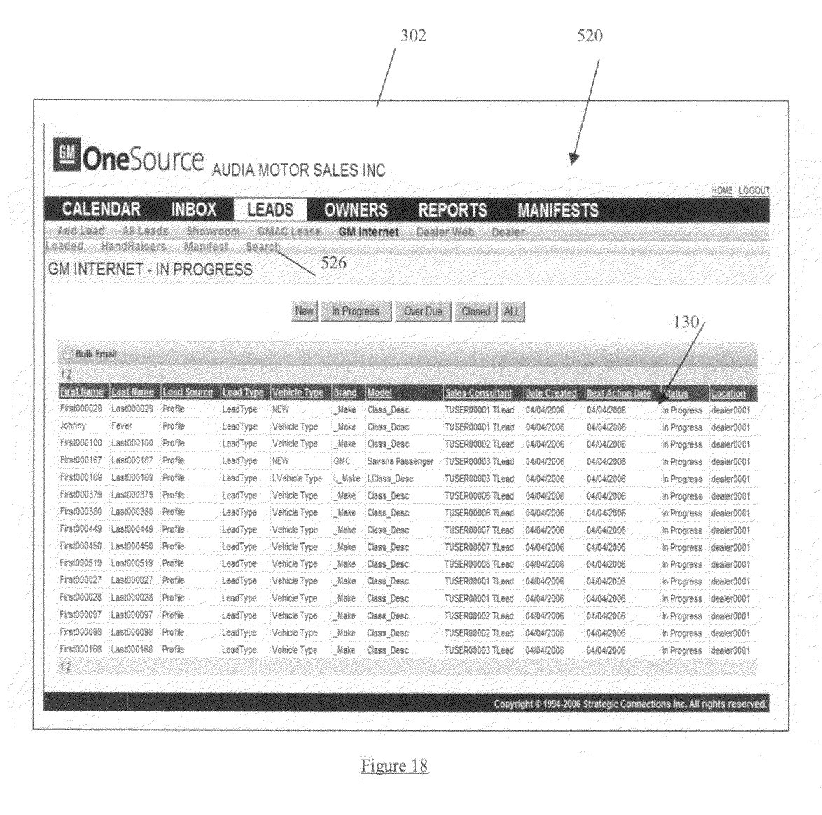

Referring again to FIG. 16, the leads 130 can be sorted by category 507 as well as by status (e.g. new, in progress, overdue, closed) through the lead view 506. Referring to FIG. 18, shown is a lead view 506 containing individual selectable leads 130 under the category of Internet/in-progress leads 130. Selection of an individual lead 130 would result in a lead form set view 520 similar to that shown in FIG. 17. Further, it is recognised that a closed status of the lead 130 can be further qualified to signify New Car Sold, Used Car Sold, Lost, Duplicate Lead, and Cancelled. Referring again to FIG. 18, a search function 526 can be used to search for leads 130 and/or owner/customer information (for that data assigned or otherwise configured as visible to the particular user), for example using search criteria of; contact names, Company Name, Home Phone, Office Phone, Cell Phone, and/or email address.

For example, lead details shown in the lead form set view 506 for lease based leads 130 can include details such as but not limited to: First Name; Last Name; Vehicle Type; Year; Brand; Model; Sold Date; Term; Maturity Date; Monthly Payment; Sales Consultant; Next Action Date; and Location. For example, lead details shown in the lead form set view 506 for showroom leads 130 can include details such as but not limited to: First Name; Last Name; Source; Vehicle Type; Year; Brand; Model; Package; Sales Consultant; Status; Date Created; Next Action Date; and Location. In view of the above, lead details shown in the lead form set view 506 for other leads 130 (e.g. Internet based, dealer based, dealer loaded, promotional based, manifest based) can include any combination of the above described lead details, as desired.

### Owners 508

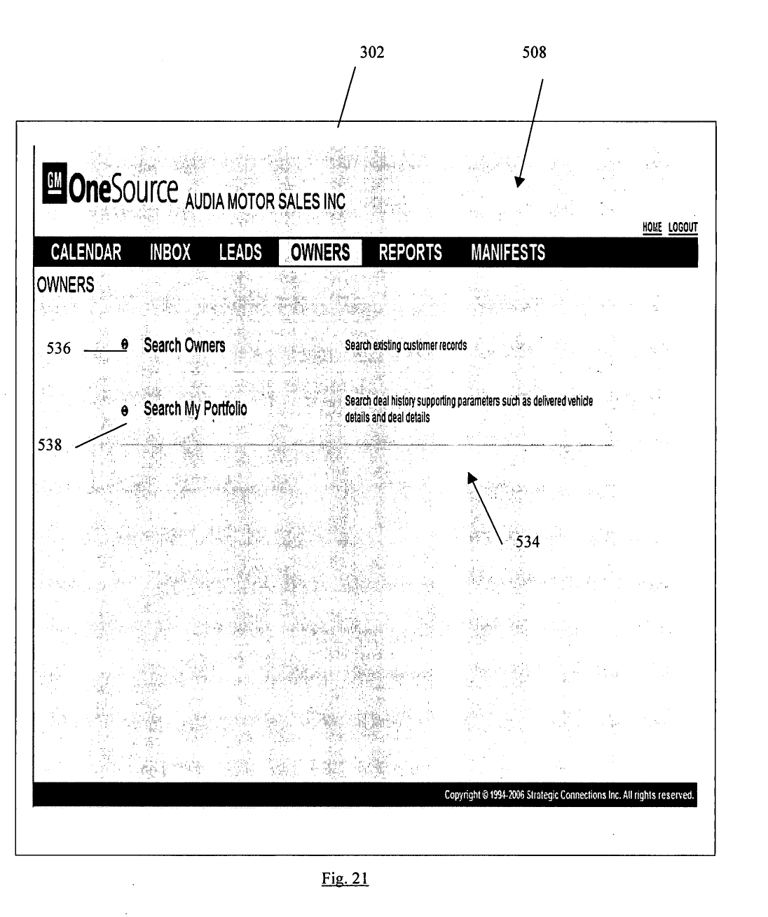

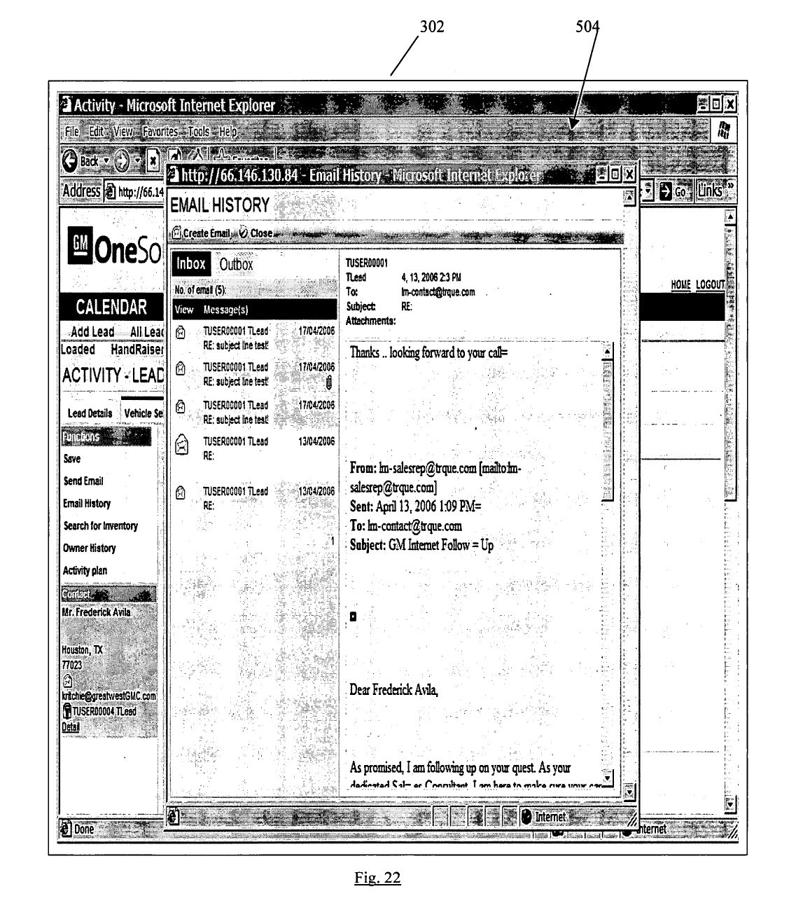

Referring to FIGS. 14 and 21, the user can access owner information 534 of any owner visible to the user. For example, the user can have access via the messaging interface 302 of system 108 wide owner information 536 and their own sales portfolio owner information 538, including the information on whether the customer is the current/past owner of a specific manufacturer brand/model of vehicle.

### Reports 510

The reports view 510 of the summary page 500 provides for user-assisted generation of the reports 142, as further described below.

### Administration View 512

The admin view 512 of the summary page 500 provides for access to administration functions of the system 108 (e.g. creation/amendment of templates 314, user/dealer 106 registration in the system 108, etc.)

### Search Inventory 514

Referring to FIGS. 9, and 16, the user through use of the tools 300 (specifically the search module 304 and the sticker module 306) can use the search category 507 to search their dealership/manufacturer inventory in response to consumer requests (e.g. leads 130) and access a selected vehicle window sticker data 307. This feature is designed to determine if a requested vehicle is in stock and/or provide a list of similar vehicles for the consumer to consider. Details on vehicles returned from the inventory search are displayed in a window sticker format and maybe forwarded to the consumer via email/messages 143 or printed in the dealership 106 as a take-away.

The user can search the vehicle inventory (e.g. represented in the data 112—see FIG. 1) by using any of the parameters such as but not limited to: Year; Make; Model; Style; VIN; Exterior color; Interior color; Vehicle Name; Engine Size; and Transmission Type, for example. Similarly, the return data from the search can include vehicle details such as but not limited to: availability code; Year; Make; Model and description; trim description; body Style; VIN; Exterior color; Interior color; Vehicle Name; Engine Size/description; available warranty; service history; new/used; mileage; Transmission Type; MSRP Price; total options; total vehicle & options; destination charge; total vehicle price; safety & security features; exterior & convenience features; spacious interior features; and power train & chassis features.

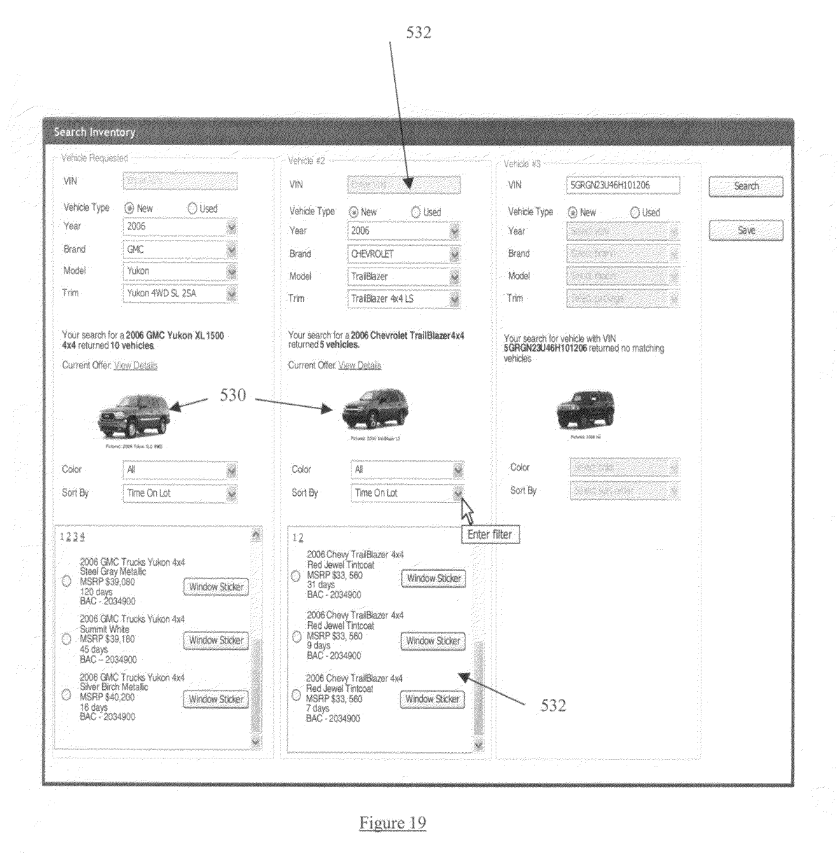

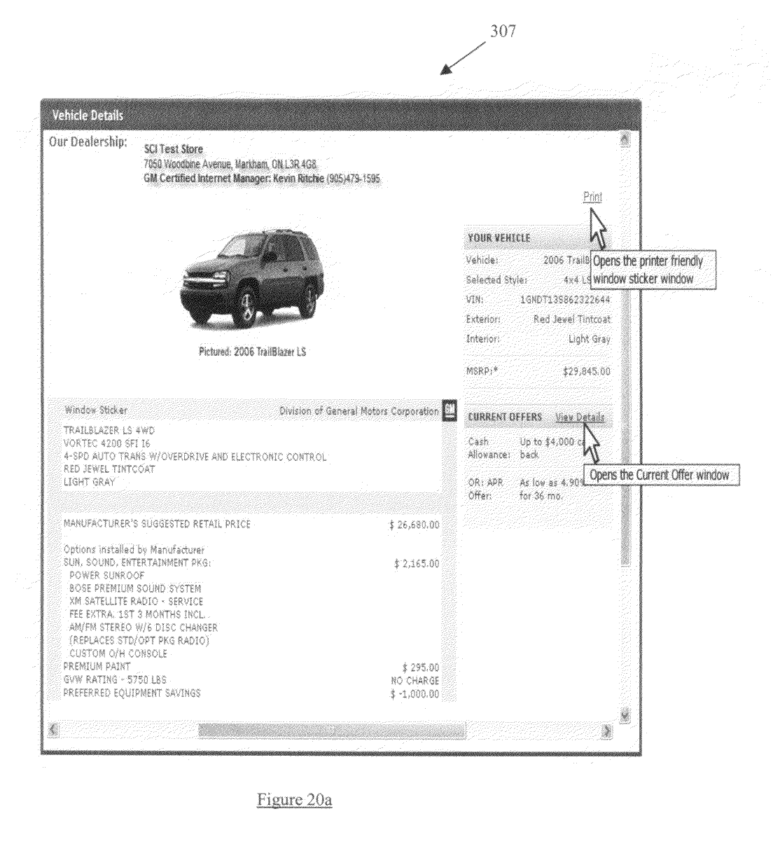

Referring to FIG. 19, also output from the search function via the messaging interface 302 can be an image 530 of the matching vehicles, along with matching vehicle information 532 that could be suitable for printing off and/or for embedding in the response message 143 for sending back to the customer. Referring to FIGS. 20a and 20b, the search function 507 can be used to obtain sticker data 307 as well, also configured for inclusion/embedding in the response message 143 for sending back to the customer. Accordingly, the output of the search function 507 can be used by the user as data for population of designated fields of the message templates 314 (see FIG. 9), in generation of the response message 143.

### Example Handling of Lead 130 by Assigned Sales Associate

The following example steps can be followed by the user assigned to handling a respective lead 130, steps in no particular order such as but not limited to:

new leads can be accessed in the message interface 302 through a number of means, e.g. the user's calendar or the leads quick views;

implementing of an activity for each lead category that is specific to the incoming lead's data source;

open up the lead activity and have a number of preset views to work from (e.g. Lead Details, Vehicle Selection, Test Drive, Appraisal and Offer) that manages the initial contact through to the close of the opportunity i.e. Car Sold or Lost. The same activity can be used to follow-up with the consumer by either phone or email, set appointments, select a vehicle and identify the final status of the opportunity;

in setting of the next activity for a respective lead 130, the user can for example adjust the next call date and time identifying the next activity as a general task or as a time sensitive action, e.g. appointment;

the status of the new activity is adjusted automatically from “New” to “In Progress” either manually by the user or upon the completion of a follow-up email/communication to the consumer;

failure to cause the status of a lead 130 to change from “New” to “In Progress” within 24 hours (or some other predefined time limit) of receiving the initial lead 130, the lead 130 is tagged as “Over Due” and the dealership/manufacturer is notified through a report 142;

failure to cause the status of a lead to change from “New” to “In Progress” within 48 hours (or some other predefined time limit) of receiving the initial lead 130, the lead 130 is tagged as “Over Due” and an email/communication is automatically sent to the consumer back through the engine 110, for example, or other network communication path, however the auto responses can be sent without changing the lead 130 status from new;

add a new activity from the contact profile and set a corresponding due date and time as general reminder for delivery or to set a 6 month (or some other predefined time limit) activity follow-up call; and

application of specific dealer settings to lead 130 handling, such as the ability to define the overdue rules by lead category that is separate from the manufacturer standard time limit for clawback (e.g. removal or otherwise inactivation of the available lead 130 from the assigned dealership 106/sales associate responsibility. Overdue rules can be set by lead category and measured in minutes/hours.

### Lead Reporting 142

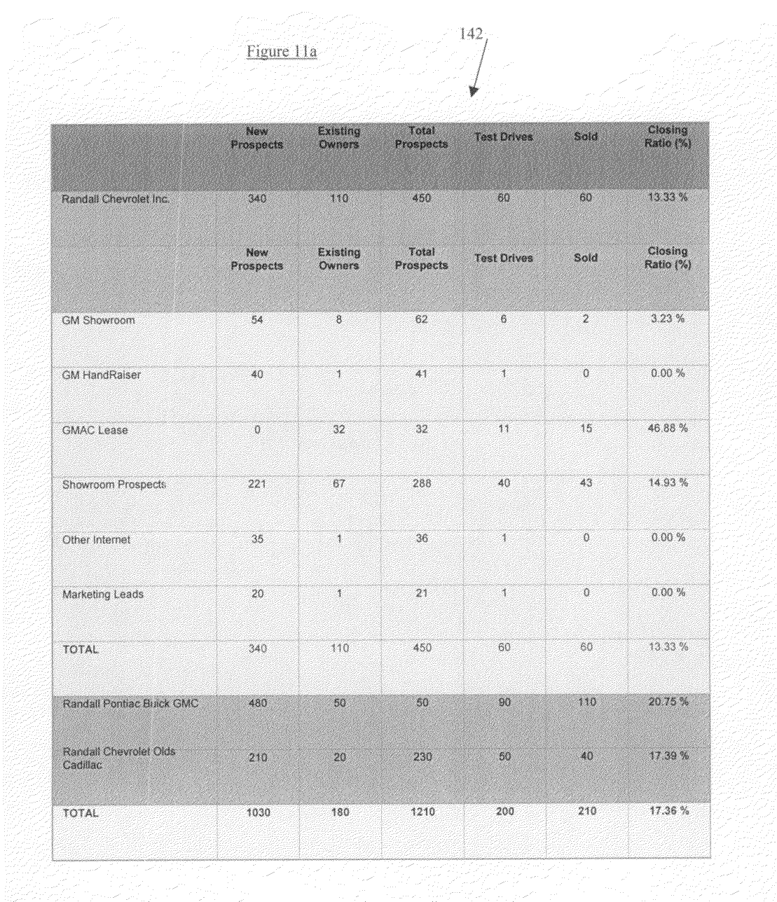

Referring to FIGS. 1 and 7, the reports 142 can be viewed online via access to the system 108, e.g. through the reports view 510—see FIG. 14, particularly to the report engine 129 and associated reports database 155. The report engine 129 prepares reporting data and generates real-time and/or historical data reports 142. For example, referring to FIG. 10, users can view the reports online through “Management Reports” screens 145 of the reports view 510 (for example reports 142 see Figures AB, AC, AD, AE) accessible via the dealer portal 132, for example. A manager of the dealership 106 and/or manufacturer can click on the desired report line of the screens 145 to display the report 142 or can edit the report parameters before running the report 142. For example, a special “Recent Activities” function of the screens 145 can provide quick access to the most commonly used (e.g. predefined) activity reports 142 for any level of user accessing the system 108. Data displayed in the report 142 can be limited by the user's access authorization profile (configured via the user login to the portal 132). Enterprise level reporting can also be available through the same capability and contain data for all Dealers 106.

### Report Types

The reports 142 can be generated based on supplying selected IDs as listed above.

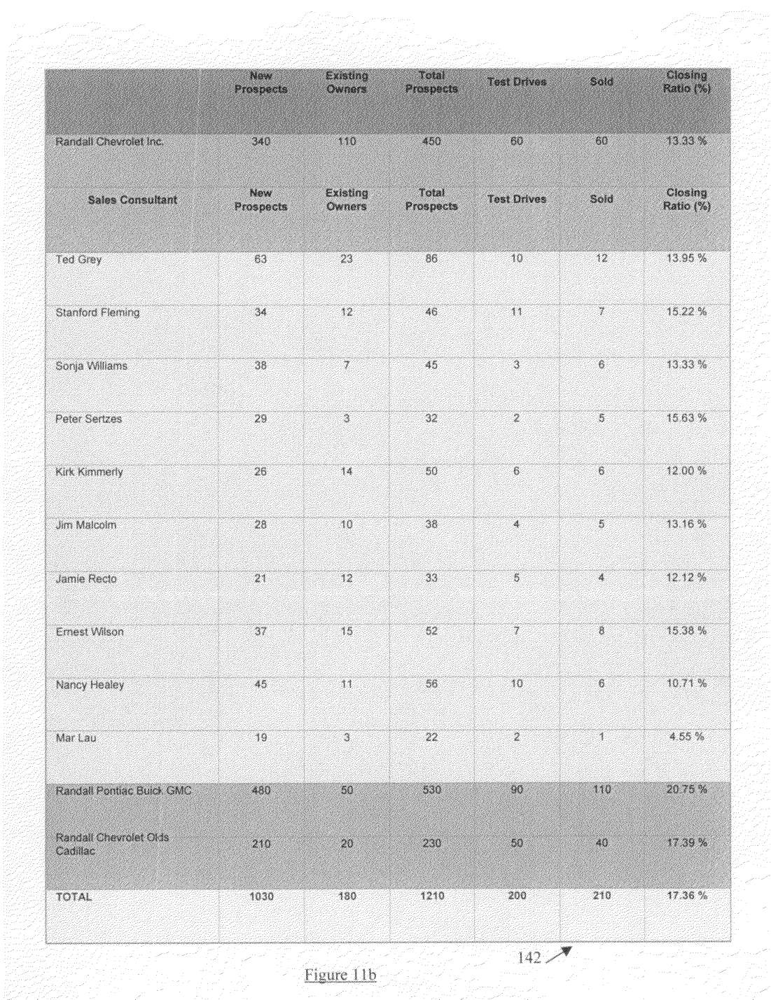

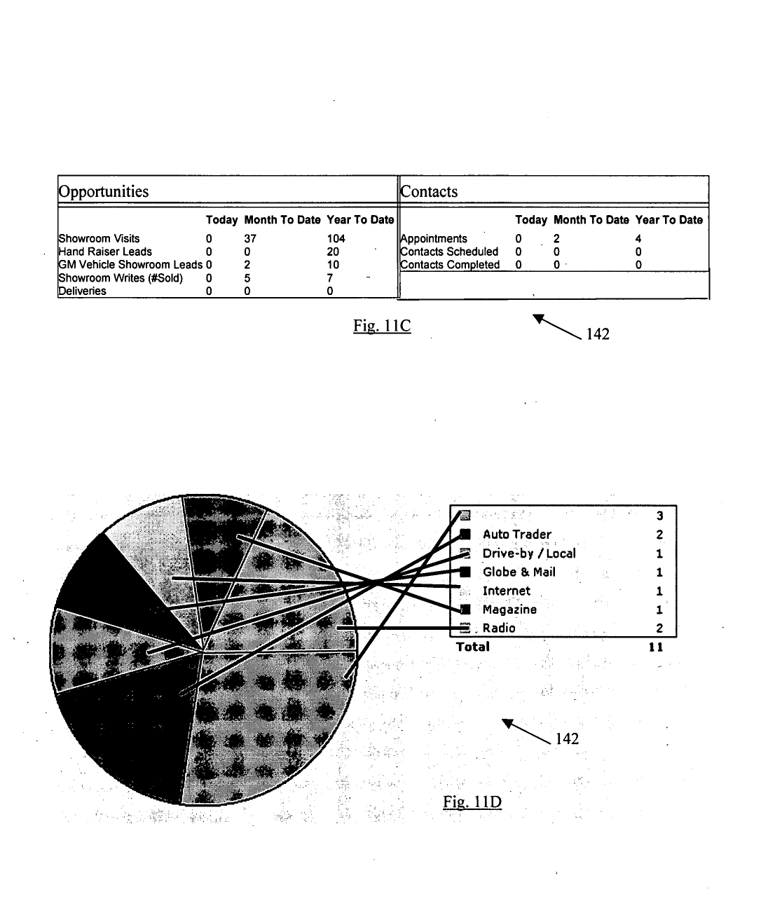

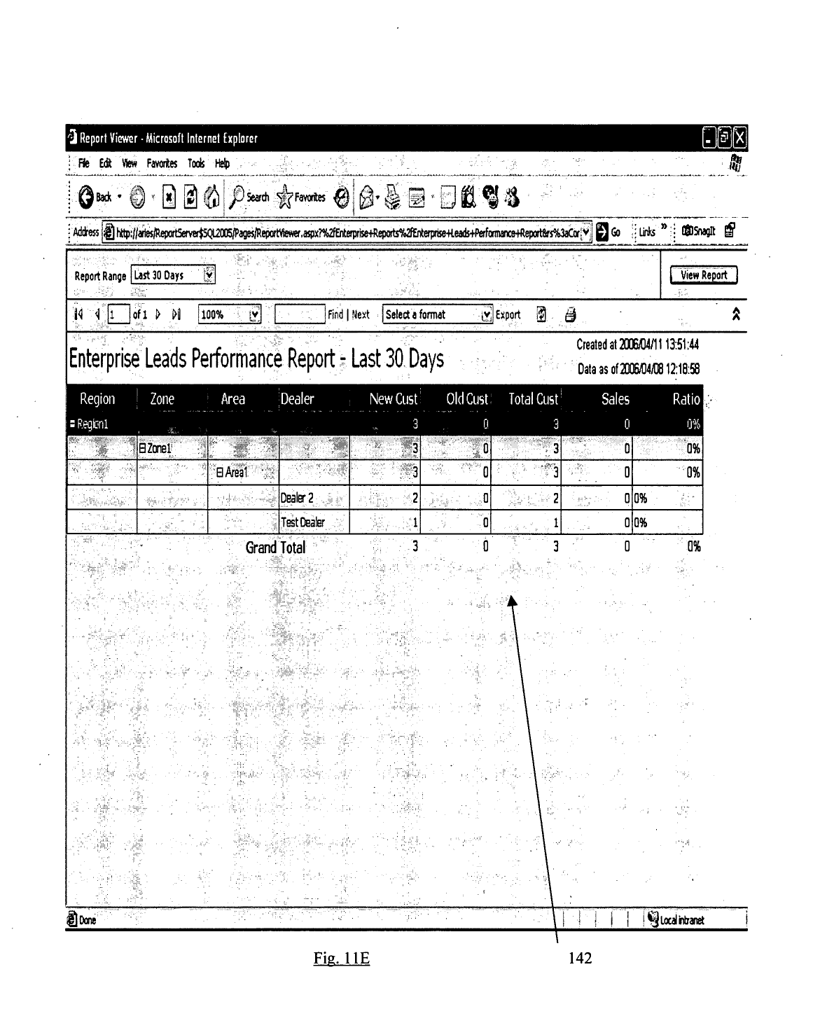

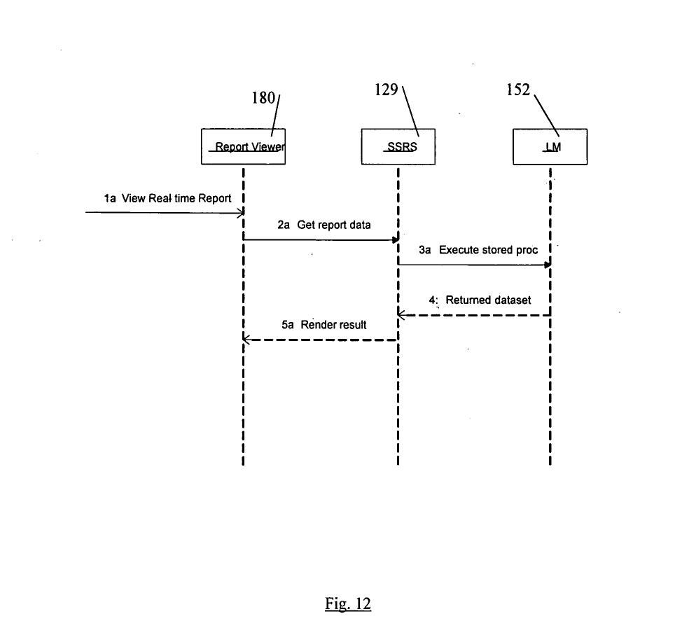

Referring again to FIG. 1, the reports 142 are based on the feedback data 140 collected by the system 108 in response to processing of the leads 130 that were assigned to the dealers 106. The report engine 129 preparation can run periodically (e.g. every night) to extract data from LC and LM databases 150,152 into LR database 155, for subsequent use in generating the reports 142. The reports 142 can include information such as but not limited to lead, activity and performance reporting at the salesperson, Dealer, zone, area, region and enterprise levels. Referring to FIG. 10, the reports can include information such as but not limited to: reports 142 on performance having a variety of data on the performance of leads 130 handling; reports 142 on activities having a variety of data on the sales activities for leads 130; and reports 142 on active leads 142 having a variety of data on the status of active leads 130. FIG. 11a, d shows an example report 142 for leads 102 by the originating source of the lead 102. FIG. 11b shows a report 142 on dealer scorecard for analysed lead 102 performance. FIG. 1 ic shows a report 142 for leads 102 by advertising source. The reports 142 can also include performance by sales as leads by sales reps with lead status, including status such as but not limited to: Offer Written; Qualify/Vehicle Selection; Appraisal. FIG. 11e shows an example report 142 generated based on time and dealer performance with summaries for respective dealer groups (e.g. geographical regions).

Different types of reports 142 can be such as but not limited to: Dealership Leads Performance; Enterprise Leads Performance; Dealership Leads Source; Enterprise Leads Source; Dealership Open Opportunity; Enterprise Open Opportunity; Dealership Overdue Opportunity; Enterprise Overdue Opportunity; Dealership Leads Status; Enterprise Leads Status; Dealership Lease Status; Enterprise Lease Status; Enterprise Leads Response (stating efficacy of response including response time measured from receipt of lead 130); Enterprise Rejected Leads; Enterprise Leads Performance; Enterprise Leads Escalation Detail; Enterprise Leads Duplicate; Dealership Leads Duplicate; Dealership Leads Detail (including Lead Contact Information, Lead Source, Vehicle of Interest, Deal Summary details); and Inactive Dealership. Further, it is recognised that the reports 142 can have a drill down potential (e.g. interactive data display potential), such that report information is provided based upon the level at which the viewer of the report has navigated.

In view of the above, the system 108 can provide a dealer 106 level report, by lead source 104, that compares the number of leads 130 the dealer 106 received to: the number of those leads 103 the dealer 106 reported as sold; the number of those leads 130 for which the data 112 provided a sales history record associated with that dealer 106; the number of those leads 130 for which data 112 provided a sales history record associated with any other dealer 106. Further, it is recognised that the reports 142 can include performance metrics of the dealerships 106 and can include date range, sales person, lead source, lead type, vehicle of interest and lead status.

The reports 142 can also include report data such as but not limited to; number of leads, # followed up on time, number of leads overdue, average length of time overdue, average initial response time, average time to close by lead source, and date range.

### Generating Reports 142

For real-time reports, data can be directly read from LM tables 152, which can save a redundant trip to copy data from LM to LR for each generation of real-time report 142. For historical reports, data from the databases 150, 152 is fed to the data warehouse 155. The data package can be either a scheduled job on nightly basis or can be called at real-time to populate reports data into the dimension and fact tables of the database 155. Once historical report data is synchronized or refreshed in the database 155, a SQL Server Analysis Service (SSAS), or other service, can be used to provide the On-Line Analytical Processing (OLAP) functionality for generation of the reports 142.

Referring to FIGS. 10 and 12, a report viewer 180 of the report screens 145 is accessed at step 1a by the user and at step 2a, the reports engine 129 is contacted (e.g. via a report request) to access the report data. At step 3a, the engine 129 accesses the database 152 and obtains at step 4a any report data sufficient to satisfy the report request. At step 5a, the report engine 129 renders the report 142 with the obtained report data and presents the rendered report 142 to the report viewer 180, for subsequent interaction (e.g. viewing) by the user.

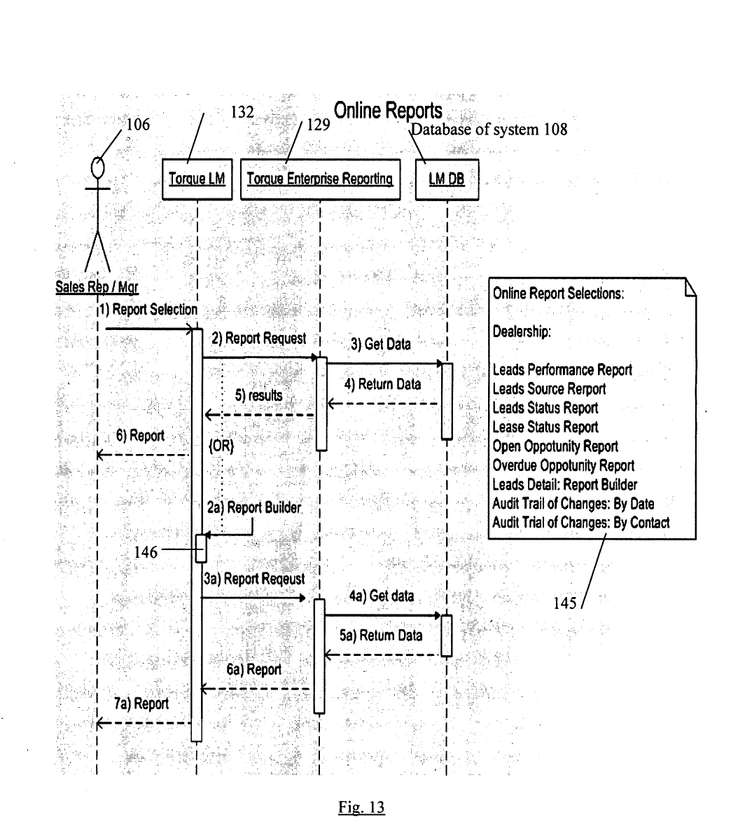

Referring to FIG. 13, shown is a further example of the report generation process. The user (e.g. of the dealership 106) accesses selections of the report viewer 180 of the report screens 145 at step 1), via the portal 132. At step 2), the report request is sent to the report engine 129 for subsequent return of the report at step 6). Otherwise, at step 2a), the user accesses a report builder 146 for configuring a customized report 142. At step 3a), the report request for the customized report is sent to the report engine 129 and the report 142 is subsequently delivered at step 7a).

In view of the above, it is recognised that steps are followed by the report engine 129 in generation of the report 142, such as but not limited to: 1. user clicks on reports for viewing a real-time, historical, scheduled report (e.g. Dealership report); 2. code behind file of an ASP NET page redirects to the URL of the report generated at the report engine 129; 3. the report engine 129 executes stored procedure against the appropriate database (e.g. 155) to get required reporting data; 4. the queried result set is returned from the database; and 5. the report engine 129 renders the report (e.g. in HTML format) and presents on the user's browser (e.g. executable application 407 of the user device 101—see FIG. 6).

### Operation

Referring to FIG. 26, shown is an example operation 600 of the system 108.

We claim:

1. A system for distributing a plurality of leads for vehicles over a network from a plurality of disparate lead sources to a targeted lead destination, the system comprising:
an import module configured for receiving the plurality of leads in an electronic format and for associating a unique identifier with each lead of the plurality of leads, each of the leads including customer contact information, customer location information, and vehicle information;
a tracking module configured for creating a report record for each said lead for use in tracking a status of each said lead, the report record associated with the unique identifier of each said lead;
a delivery module configured for assigning each said lead to a selected vehicle dealership based on the lead information, the vehicle dealership associated with a network address of the targeted lead destination and for communicating each said lead to the network address; and
a collector module configured for receiving from the targeted lead destination respective feedback data associated with each said lead, the respective feedback data including the unique identifier of each said lead, and configured for storing the feedback data for each said lead in the report record associated with the unique identifier of each said lead.

2. The system of claim 1, wherein the unique identifier is selected from the group comprising: a batch ID; a lead ID, a source ID; a customer ID; and a dealership ID.

3. The system of claim 2, wherein the unique identifier is a combination of two or more of the IDs.

4. The system of claim 2 further comprising the delivery module configured for assembling each said lead into a batch for delivery of the leads to the targeted lead destination as a group of leads.

5. The system of claim 4 further comprising a processing module configured for validating the lead information prior to delivery of each said lead.

6. The system of claim 5, wherein the validation type is selected from the group comprising: location information validation; network address validation; dealer information validation; duplication validation; contact information validation; and mandatory fields validation.

7. The system of claim 6 further comprising the collector module configured for receiving response messages from the vehicle dealership pertaining to processing of each said lead and for forwarding the response messages to the respective customers associated with the leads.

8. The system of claim 7 further comprising the collector module configured for receiving new lead information from the dealership as part of the feedback data for subsequent processing by the import, the tracking, and the delivery modules for creation of a new lead.

9. The system. of claim 8, wherein the customer location information of the lead information is used to select the dealership having a location in a predefined proximity to the customer location.

10. The system of claim 8, wherein the lead information used to select the dealership is selected from the group comprising: a lead category of each said lead, the lead category including at least one of a vehicle type, a customer type, and a source type associated with the dealership; a lead follow-up performance rating of the dealership; and monitoring of the lead throughput for facilitating the selection of a secondary dealership associated with a second targeted lead destination different from the targeted lead destination, the targeted lead destination having a maximum lead throughput.

11. A method for distributing a plurality of leads for vehicles over a network from a plurality of disparate lead sources to a targeted lead destination, the method comprising the acts of:
receiving the plurality of leads in an electronic format;
associating a unique identifier with each lead of the plurality of leads, each of the leads including customer contact information, customer location information, and vehicle information;
creating a report record for each said lead for use in tracking a status of each said lead, the report record associated with the unique identifier of each said lead;
assigning each said lead to a selected vehicle dealership based on the lead information, the vehicle dealership associated with a network address of the targeted lead destination;
communicating each said lead to the network address;
receiving from the targeted lead destination respective feedback data associated with each said lead, the respective feedback data including the unique identifier of each said lead, and
storing the feedback data for each said lead in the report record associated with the unique identifier of each said lead.

12. The method of claim 11, wherein the unique identifier is selected from the group comprising: a batch ID; a lead ID, a source ID; a customer ID; and a dealership ID.

13. The method of claim 12, wherein the unique identifier is a combination of two or more of the IDs.

14. The method of claim 12 further comprising the act of assembling each said lead into a batch for delivery of the leads to the targeted lead destination as a group of leads.

15. The method of claim 14 further comprising the act of validating the lead information prior to delivery of each said lead.

16. The method of claim 15, wherein the validation type is selected from the group comprising: location information validation; network address validation; dealer information validation; duplication validation; contact information validation; and mandatory fields validation.

17. The method of claim 16 further comprising the acts of receiving response messages from the vehicle dealership pertaining to processing of each said lead and forwarding the response messages to the respective customers associated with the leads.

18. The method of claim 17 further comprising the act of receiving new lead information from the dealership as part of the feedback data for subsequent processing by the import, the tracking, and the delivery modules for creation of a new lead.

19. The method of claim 18, wherein the customer location information of the lead information is used to select the dealership having a location in a predefined proximity to the customer location.

20. The method of claim 18, wherein the lead information used to select the dealership is selected from the group comprising: a lead category of each said lead, the lead category including at least one of a vehicle type, a customer type, and a source type associated with the dealership; a lead follow-up performance rating of the dealership; and monitoring of the lead throughput for facilitating the selection of a secondary dealership associated with a second targeted lead destination different from the targeted lead destination, the targeted lead destination having a maximum lead throughput.

21. A system for providing a plurality of qualified leads for vehicles over a network to a selected vehicle dealership, the system comprising:
a receipt module configured for receiving a plurality of initial leads in an electronic format and for identifying a unique identifier with each lead of the plurality of initial leads, each of the initial leads including customer information and vehicle information;
a data module configured for supplementing the lead information with supplemental information identified from a data store based on the lead information to transform the plurality of initial leads into the plurality of qualified leads, through searching the data store for any matches to selected data fields of the lead information, the data store including the supplemental information that is associated with at least one of the customer information or information on the selected vehicle dealership, each of the plurality of qualified leads retaining the unique identifier associated with each of the corresponding initial leads; and
a delivery module configured for communicating each said qualified lead to the selected vehicle dealership based on the lead information for subsequent lead follow-up.

22. The system of claim 21, wherein the supplemental information is selected from the group comprising: prospective customer information including contact information; existing customer information including contact information; existing dealership information; historical vehicle service records; and historical vehicle purchase records.

23. The system of claim 22, wherein the supplemental information is historical vehicle financing information.

24. The system of claim 23, wherein the supplemental information is scheduled vehicle maintenance data obtained from on-board vehicle record systems.

25. The system of claim 24, wherein the unique identifier includes an ID selected from the group comprising: a batch ID; a lead ID, a source ID; a customer ID; and a dealership ID.

26. The system of claim 22 further comprising an activity module configured for associating at least one activity with each said qualified lead, each of the activities coupled to each respective said qualified lead through the respective unique identifier.

27. The system of claim 26, wherein each said activity includes parameters selected from the group comprising: the unique identifier of the corresponding said lead; an activity name; a description of each task of the activity; and a date and time for implementing.

28. The system of claim 27 further comprising a message template library containing a plurality of message templates, at least one of the message templates of the plurality of message templates associated with said activity, the message templates for facilitating formulation of a response message to the customer of the qualified lead through population of response data based on the respective task of said activity.

29. The system of claim 28, wherein each of the message templates includes a template ID for associating with a status of the qualified lead.

30. The system of claim 28 further comprising a data receipt module configured for monitoring the status of the qualified lead in processing by the selected vehicle dealership during follow-up and for communicating the status including the unique identifier of the qualified lead to a reporting engine.

31. A method for providing a plurality of qualified leads for vehicles over a network to a selected vehicle dealership, the method comprising the acts of:
receiving a plurality of initial leads in an electronic format;
identifying a unique identifier with each lead of the plurality of initial leads, each of the initial leads including customer information and vehicle information;
supplementing the lead information with supplemental information identified from a data store based on the lead information to transform the plurality of initial leads into the plurality of qualified leads, through search results of the data store for any matches to selected data fields of the lead information, the data store including the supplemental information that is associated with at least one of the customer information or information on the selected vehicle dealership, each of the plurality of qualified leads retaining the unique identifier associated with each of the corresponding initial leads; and
communicating each said qualified lead to the selected vehicle dealership based on the lead information for subsequent lead follow-up.

32. The method of claim 31, wherein the supplemental information is selected from the group comprising: prospective customer information including contact information; existing customer information including contact information; existing dealership information; historical vehicle service records; and historical vehicle purchase records.

33. The method of claim 32, wherein the supplemental information is historical vehicle financing information.

34. The method of claim 33, wherein the supplemental information is scheduled vehicle maintenance data obtained from on-board vehicle record systems.

35. The method of claim 34, wherein the unique identifier includes an ID selected from the group comprising: a batch ID; a lead ID, a source ID; a customer ID; and a dealership ID.

36. The method of claim 32 further comprising the act of associating at least one activity with each said qualified lead, each of the activities coupled to each respective said qualified lead through the respective unique identifier.

37. The method of claim 36, wherein each said activity includes parameters selected from the group comprising: the unique identifier of the corresponding said lead; an activity name; a description of each task of the activity; and a date and time for implementing.

38. The method of claim 37 further comprising the act of accessing a message template library containing a plurality of message templates, at least one of the message templates of the plurality of message templates associated with said activity, the message templates for facilitating formulation of a response message to the customer of the qualified lead through population of response data based on the respective task of said activity.

39. The method of claim 38, wherein each of the message templates includes a template ID for associating with a status of the qualified lead.

40. The method of claim 38 further comprising the act of monitoring the status of the qualified lead in processing by the selected vehicle dealership during follow-up and for communicating the status including the unique identifier of the qualified lead to a reporting engine.
